(19) United States
(12) Patent Application Publication
(10) Pub. No.: US 2017/0103426 A1
(43) Pub. Date: Apr. 13, 2017

(54) MESSAGING NOVELTY DEVICE

(71) Applicant: Jishu Technologies, LLC, San Mateo, CA (US)

(72) Inventors: Neil Peretz, San Mateo, CA (US); Scott Fullam, PALO ALTO, CA (US)

(73) Assignee: Jishu Technologies, LLC, San Mateo, CA (US)

(21) Appl. No.: 15/291,994

(22) Filed: Oct. 12, 2016

Related U.S. Application Data
(60) Provisional application No. 62/241,069, filed on Oct. 13, 2015.

(51) Int. Cl. G06Q 30/02; A63F 9/06; G06F 3/0346; H04W 4/18; G09G 5/22

(52) U.S. Cl. CPC G06Q 30/0269; H04W 4/18; G09G 5/22; G06F 3/0346; A63F 9/0612; G09G 2330/02; G09G 2354/00

(57) ABSTRACT

A messaging novelty device. A messaging novelty device can include a customizable message provisioning system and a customizable display system. A method of operating a messaging novelty device can include controlling reproduction of content on a customizable display system of the novelty device according to how a user interacts with the novelty device and content presentation rules.

### CROSS-REFERENCE TO RELATED APPLICATIONS

The present application claims priority to U.S. Provisional Patent Application No. 62/241,069, filed on Oct. 13, 2015, which is incorporated by reference herein.

### BRIEF DESCRIPTION OF THE DRAWINGS

FIG. 1 depicts a front view of an example of a novelty device.

FIG. 2 depicts a cross-sectional view of an example of a novelty device.

FIG. 3 depicts a front perspective view of an example of a customized die.

FIG. 4 depicts a diagram of an example of a system for controlling customizable message provisioning in a novelty device.

FIG. 5 depicts a flowchart of an example of a method for controlling a customizable display system integrated as part of a novelty device.

FIG. 6 depicts a diagram of an example of a message provisioning system and a customizable display system integrated as part of a novelty device.

FIGS. 7A and 7B depict a diagram of a flowchart of an example operation of a novelty device with an integrated customizable display system and a customizable message provisioning system.

FIG. 8 depicts a diagram of a solar powered customizable display system integrated with a novelty device.

FIG. 9 depicts a diagram of a movement activated self-powering customizable display system integrated with a novelty device.

FIG. 10 depicts a diagram of a battery powered customizable display system integrated with a novelty device.

FIG. 11 depicts a diagram of a customized content maintenance system.

FIG. 12 depicts a diagram of an example of a customized content reproduction management system.

FIG. 13 depicts a flowchart of an example of a method for reproducing content at a customizable display system integrated as part of a novelty device based on user interaction with the novelty device.

FIG. 14 depicts a flowchart of an example of a method for reproducing content at a customizable display system integrated as part of a novelty device based on environmental conditions at the novelty device.

FIG. 15 depicts a flowchart of an example of a method of reproducing content on a customizable display system according to user personas.

### DETAILED DESCRIPTION

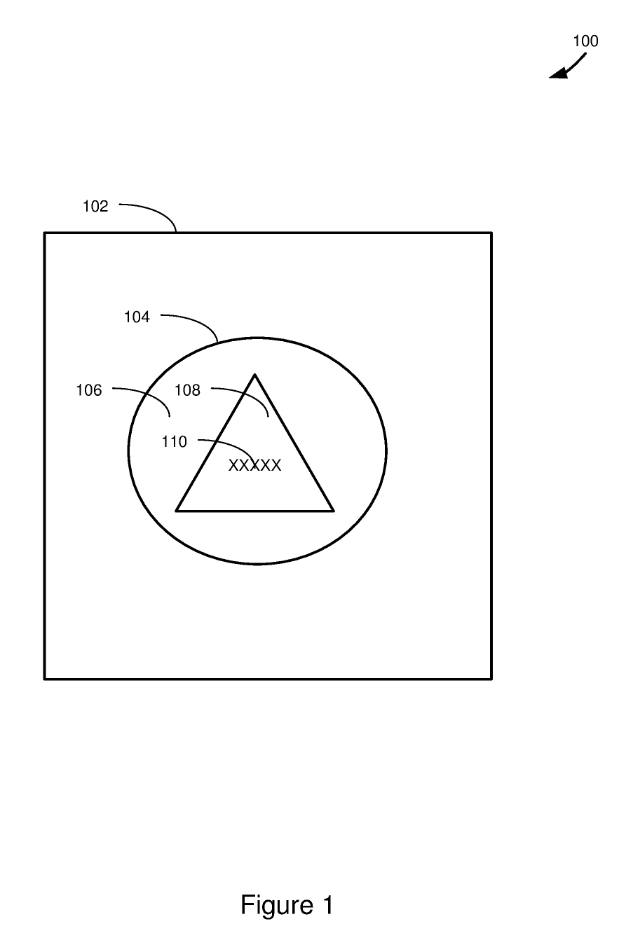

FIG. 1 depicts a front view of an example of a novelty device 100. The novelty device 100 includes a housing 102 enclosing an inner reservoir. The housing 102 can be of an applicable shape. For example, the housing can be a sphere, a cube, a cylinder, or resembling the shape of an object such as a football helmet, a book, or a hockey puck. The housing 102 can be comprised of one or a combination of applicable materials. For example the housing 102 can be comprised of plastic. In various implementations, the housing 102 is of a size to allow for the novelty device 100 to be manipulated by a human being, either an adult or a child. For example, the housing 102 can be of a size such that a child can pick up and shake the novelty device 100. The housing 102 can include indicia and ornamental decorations. For example, the housing 102 can include ornamental decorations, such as a sports team logo, painted onto the outer surface of the housing.

The housing 102 contains an inner reservoir. An inner reservoir within the housing 102 contains a liquid 106 in a sealed manner. The liquid 106 contained within an inner reservoir can include a dye to limit the ability to view a die contained within the inner reservoir. The inner reservoir can be of a shape to allow a contained die to move and rotate freely within a contained liquid. In various implementations, an inner reservoir within the housing 102 can be cylindrical shaped. The inner reservoir can have multiple chambers where the die can float into. Each chamber can have its own window 104. An inner reservoir contained within the housing 102 can extend across an entire diameter of the housing 102 or an entire length of the housing 102.

The novelty device 100 includes a window 104 or multiple windows implemented as part of the housing 102. The window 104 functions to allow a user to view inside an inner reservoir contained by the housing 102. Through the window 104 a user can view a customized die and the liquid 106 contained within an inner reservoir. The window 104 can be configured to form part of the inner reservoir. Specifically, the window 104 can form at least a portion of a top, bottom or side of an inner reservoir contained by the housing 102. For example, if an inner reservoir is cylindrically shaped, the window 104 can form a top of the inner reservoir. The window 104 can be comprised of a transparent material. For example, the window 104 can be comprised of an acrylate polymer, a butyrate polymer, or a polycarbonate polymer.

The novelty device 100 includes a customized die 108 contained, along with the liquid 106, by an inner reservoir within the housing 102. The customized die 108 includes at least two distinct faces. Faces of the customized die 108 can be of an applicable shape. For example, faces of the customized die 108 can be triangular shaped, as shown in FIG. 1 of the example novelty device 100. In various implementations, faces of the customized die 108 can be of different shapes. For example a first face of the customizable die 108 can be shaped as a triangle, while a second face of the customized die 108 can be shaped as a square.

The customized die 108 is configured to float within the liquid 106 contained within an inner reservoir. The customized die 108 can be comprised of an applicable material and be of an applicable design to cause the customized die 108 to float within the liquid 106. The die can have a chamber that is filled with air or the die can be constructed from a material that is less dense than the liquid. For example, the customized die 108 can be hollow to cause the customized die 108 to float within the liquid 106. In floating within the liquid 106, when the novelty device 100 is manipulated to specific positions, the customized die 108 floats towards the window 104, where a portion of the customized die 108 comes into contact with the window 104.

The customized die 108 includes indicia or script 110 on at least one of a plurality of faces. The indicia or script 110 can form words or phrases. Depending upon implementation-specific or other considerations, one face of the customized die 108 includes indicia or script while another face of the customized die 108 does not include indicia or script. The indicia or script 110 can be raised with respect to a corresponding face that the indicia or script are present on. As the indicia or script 110 is raised with respect to the face of the customized die 108, when a user manipulates the novelty device 100 to a specific position, the customized die 108 floats towards the window 104 and the indicia or script 110 comes into contact with the window 104, where the indicia or script 110 can be viewed while the remaining portions of the customized die 108, including the specific face of the customized die 108, remain hidden by the liquid 106. As a result, the indicia or script 110 appear to “magically” come into view.

In a specific implementation, a user can input indicia or script for the customized die 108 through an application or a web-based application. In various implementations, an application can limit or modify indicia or script that a user inputs according to either or both the size of the indicia or script or a size of a face that will include the indicia or script. For example, an application can remove words from a message input by a user to ensure that the message can fit on a face of the customized die 108. In various implementations, an application presents indicia or script to a user, which the user can select to be included on the customized die 108.

The customized die 108 is either a modified version of an original die created by a factory that created the novelty device, or a new die that is different from the original die. In manufacturing the novelty device 100, a factory version including an original die is obtained. The housing 102 can be opened and the inner reservoir can be accessed to remove the original die. The customized die 108 can then be placed in the inner reservoir which is sealed again and the housing 102 is closed. Depending upon implementation-specific or other considerations, the liquid 106 can be replaced or replenished while accessing the inner reservoir to remove the original die and place the customized die 108 within the inner reservoir.

The customized die 108 can be created using an applicable 3D printing process. Depending upon implementation-specific or other considerations, the customized die 108 can be created by using 3D printing to modify an original die. For example, script or indicia on an original die can be modified through a 3D printing process to change the script or indicia and subsequently create the customized die 108. Further depending upon implementation-specific or other considerations, the customized die can be created by using 3D printing to generate a new die, which serves as the customized die 108. An original die can be used in generating a model for 3D printing of a new die. For example, a model of a new die can be generated based on a shape and size of an original die. In generating a model of a new die, an original die can be scanned with a 3D scanner or by using a camera and photogrammetry software to generate a digital model of a new die. For example the original die can be scanned with a 3D scanner to create a digital model of a new die in an applicable file format, such as a stereolithography file format. The new die design can be created with CAD software that to an output file that controls a 3-D printer or an engraving or embossing system.

In a specific implementation, the customized die 108 is created through an applicable extrusion deposition based 3D printing process, a 2D printing or embossing process, or engraved using a 3D carving process. In various implementations, the customized die 108 can be created by extruding a thermoplastic material that is heated up and then flowed out of an extruder to generate the customized die 108. For example, small beads of a thermoplastic material can be extruded to form the customized die 108 by controlling the flow of heated thermoplastic from an extrusion nozzle. Examples of thermoplastic materials that can be used to create the customized die through an extrusion deposition based 3D printing process include acrylonitrile butadiene styrene polymers, polycarbonate polymers, polylactic acid polymers, high density polyethylene polymers, PC/ABS polymers, polyphenylsulfone polymers, and high impact polystyrene polymers.

In a specific implementation, the customized die 108 is created through an applicable selective fusing of granular materials based 3D printing process. In various implementations, the customized die 108 can be created by sintering or melting granular material to form the customized die 108. The customized die 108 can be created using an applicable sintering or melting process, such as selective laser sintering, selective laser melting, or electron beam melting. A granular material that is used to generate the customized die 108 can include a polymer. In various implementations, the customized die 108 can be created by binding together granular materials in layers. For example, the customized die 108 can be created by spreading a layer of granular material and depositing a binder based on a design of the customized die to form a layer of the customized die 108. This can be repeated layer by layer until the complete customized die 108 is created.

In a specific implementation, the customized die 108 is created through an applicable stereolithography based 3D printing process. In various implementations, a thin layer of a photopolymer can be deposited in layers that are subsequently cured to form the customized die 108. For example, a liquid photopolymer can be deposited in a thin layer which is then cured through exposure to UV light to solidify the photopolymer layer, and this process is repeated until the customized die is created 108.

In an example of operation of the example novelty device 100 shown in FIG. 1, a user shakes the novelty device 100. This causes the customized die 108 to float within the liquid 106 contained in an inner reservoir within the housing 102. In the example of operation of the example novelty device 100 shown in FIG. 1, the user positions the novelty device to cause the customized die 108 to float towards the window 104. As the novelty device 100 is shaken to cause the customized die 108 to move within the liquid 106 contained in an inner reservoir, it is random which portion of the customized die, corresponding to a specific face of the customized die 108, comes into contact with the window 104 for the user to view. We can alter the density of the material on one or more sides of the die 108 to increase or decrease the probability that a particular die face 302 floats to the top.

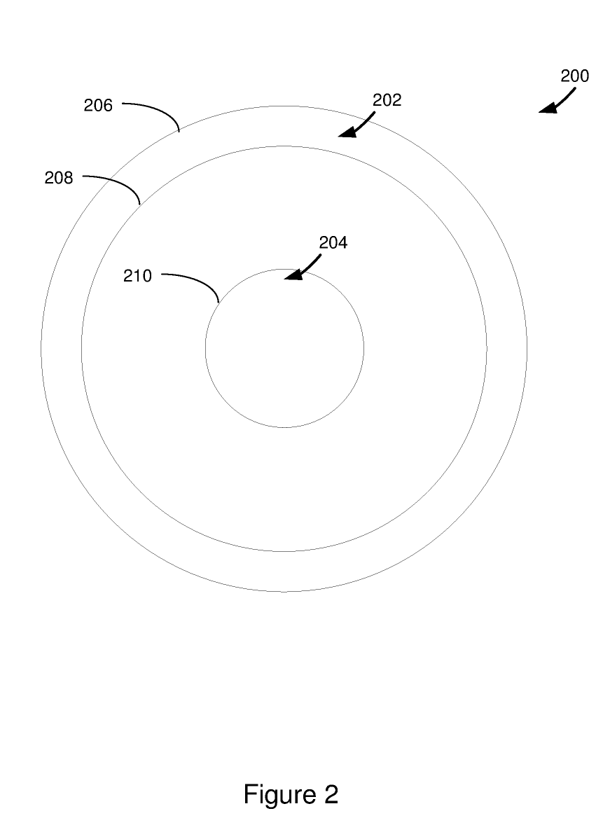

FIG. 2 depicts a cross-sectional view of an example of a novelty device 200. The novelty device 200 includes a housing 202 enclosing an inner reservoir 204. While the housing 202 is shown to be of a circular shape, the housing 202 can be of an applicable shape. The housing 202 includes an outer wall 206 and an inner wall 208. The outer wall 206 of the housing 202 is a surface that a user can engage to manipulate the novelty device 200. The outer wall 206 and the inner wall 208 have diameters to define a thickness of the housing 202. The outer wall 206 and the inner wall 208 have diameters to define a thickness of the housing 202 that allows the novelty device 200 to be picked up and manipulated.

The inner reservoir 204 functions to contain a liquid and a customized die. A liquid contained within the inner reservoir 204 can include a dye to limit the view of a contained customized die for a user. While the inner reservoir 204 is shown to be cylindrical in shape, the inner reservoir 204 can be of an applicable shape. The inner reservoir 204 can be of a size to allow a contained customized die to rotate 360° in all directions with respect to the customized die.

The inner reservoir 204 includes a reservoir wall 210 that defines the inner reservoir 204 within the housing 202. While the reservoir wall 210 is shown to be cylindrical, the reservoir wall 210 can be of an applicable shape. The reservoir wall 210 can be of a size to allow a contained customized die to rotate 360° in all directions with respect to the customized die within the inner reservoir 204. The inner reservoir 204 can contain a customized die created using an applicable 3D printing process, such as the 3D printing processes described in this paper.

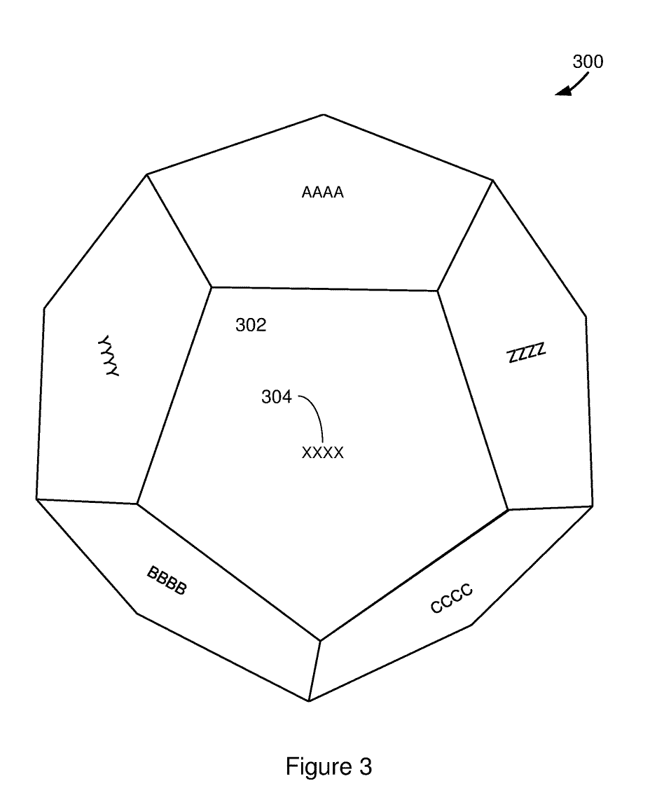

FIG. 3 depicts a front perspective view of an example of a customized die 300. The example customized die 300 shown in FIG. 3 is dodecahedron in shape. The customized die 300 can be created using an applicable 3D printing or engraving process, such as the 3D printing processes described in this paper. Depending upon implementation-specific or other considerations, the customized die 300 can be a modified version of an original die, or an entirely new die.

The customized die 300 includes a plurality of faces, e.g. face 302. Each face includes indicia or script 304. Each face can include different indicia or script. Indicia or script can be raised from or engraved into a corresponding face upon which it is positioned. As a result, indicia or script can be viewed when it comes into contact with a window while the remaining portions of the customized die 300, including the other faces and other indicia or script, remain hidden.

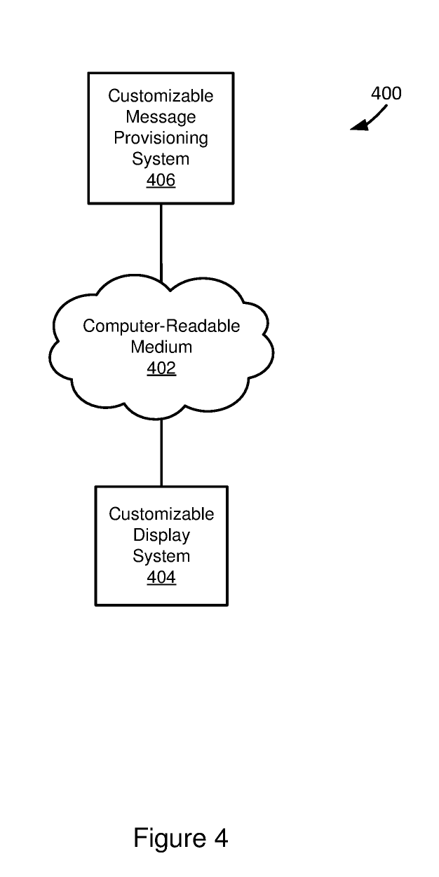

FIG. 4 depicts a diagram 400 of an example of a system for controlling customizable message provisioning in a novelty device. The system of the example of FIG. 4 includes a computer-readable medium 402, a customizable display system 404, and a customizable message provisioning system 406.

In the example system shown in FIG. 4, the customizable display system 404 and the customizable message provisioning system 406 are coupled to each other through the computer-readable medium 402. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 402 is intended to represent a variety of potentially applicable technologies. For example, the computer-readable medium 402 can be used to form a network or part of a network. Where two components are co-located on a device, the computer-readable medium 402 can include a bus or other data conduit or plane. Where a first component is co-located on one device and a second component is located on a different device, the computer-readable medium 402 can include a wireless or wired back-end network or LAN. The computer-readable medium 402 can also encompass a relevant portion of a WAN or other network, if applicable.

The computer-readable medium 402, the customizable display system 404, the customizable message provisioning system 406, and other applicable systems or devices described in this paper can be implemented as a computer system, a plurality of computer systems, or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. Another example of operating system software with its associated file management system software is the FreeRTOS operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general-purpose or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The customizable display system 404 functions to render content to a user. As part of rendering content to a user, the customizable display system 404 can function to display customized messages, for example one or a combination of text or indicia. The customizable display system 404 can be integrated as part of the novelty devices described in this paper. In various implementations, the customizable display system 404 can replace the customized die described in this paper. As a result, when a user manipulates the novelty devices described in this paper, the user can view a message on a display of the customizable display system 404. In various implementations, the customizable display system 404 is rigidly secured within a novelty device. As a result, when a user manipulates the novelty devices described in this paper, the user views the same display of the customizable display system 404. The customizable display system 404 can be configured to display a plurality of different messages. As a result, a user can see different messages when manipulating a novelty device, to create the appearance that the customizable display system 404 is actually moving within the novelty device as the user manipulates the novelty device. A novelty device integrated with the customizable display system 404 can be an applicable mobile device for displaying messages or indicia to a user. For example, the novelty device can be a smartphone upon which the customizable display system is operated.

In a specific implementation, the customizable display system 404 functions to display messages or indicia using content data. Content data includes applicable data for use by the customizable display system 404 to reproduce content for a user. For example, content data can indicate what content to reproduce and how to reproduce the content. Content data can include data used by the customizable display system 404 to reproduce a phrase. Content data can also include data used by the customizable display system 404 to reproduce an image. Additionally, content data can include data used by the customizable display system 404 to reproduce a sound.

In a specific implementation, the customizable display system 404 functions to display messages or indicia based on interaction data. Interaction data includes applicable data signifying user interaction with the customizable display system 404 or a novelty device integrated with the customizable display system 404. For example, interaction data can include data indicating certain sounds made by a user in interacting with a novelty device. In another example, interaction data can include data indicating how a user has physically manipulated a novelty device. In displaying message or indicia based on interaction data, the customizable display system 404 can receive presentation instructions according to the interaction data, and subsequently display content according to the presentation instructions. For example, if interaction data indicates a user has moved the customizable display system 404, then the customizable display system 404 can receive presentation instructions indicating to display a new message and subsequently display the new message.

In a specific implementation, the customizable display system 404 functions to display messages or indicia based on content presentation rules. Content presentation rules include applicable rules for managing reproduction of content through the customizable display system 404. For example, content presentation rules can specify messages or indicia to display, whether to display the messages or indicia pseudo-randomly, conditions for displaying messages or indicia, and sounds to reproduce, e.g. when specific messages or indicia are displayed in response to user interaction with a novelty device. For example, content presentation rules can specify to display a specific message when a user moves or shakes a novelty device, including the customizable display system 404. Reproduction of content, as used in this paper, refers to presenting content to a user in a form in which it is capable of being perceived by a human being. For example, reproduction of content can include displaying a message or playing a sound.

In a specific implementation, content data specifies a list of indicia or messages to display to a user. Additionally, content presentation rules can specify rules for displaying indicia or messages within a list of indicia or messages included as part of content data. For example content presentation rules can specify to display a first message if a user shakes a novelty device, and to display a second message if a user shakes the novelty device again within thirty seconds of first shaking the novelty device.

In a specific implementation, content data specifies a riddle and hints to the riddle to present to a user. Additionally, content presentation rules can specify rules for displaying a riddle and hints to the riddle to a user. For example, content presentation rules can specify to display a hint to a riddle if a user fails to interact with a novelty device for a certain amount of time after being displayed the riddle. In another example content presentation rules can specify to display a hint to a riddle if a user moves or shakes a novelty device the user is presented with the riddle.

In a specific implementation, content data for use in reproducing content can be provided, or otherwise made available to a user, in response to a stimulus. Example stimulus include rewards for actions taken by a user and the purchasing of a right to use the content. For example, a user can purchase a right to display a list of indicia or messages, and content data and associated content presentation rules for the list of indicia or messages can be provided to an applicable system for managing display of the list of indicia or messages, such as the customizable message provisioning systems described in this paper.

In a specific implementation, content presentation rules include instructions for reproducing related content at a customizable display system in a set order. For example, content presentation rules can specify to display a first phrase, and in response to a user manipulating a customizable display system or a novelty device integrated with the customizable display system, display a next phrase within a list of phrases. Additionally, content presentation rules can be used to display phrases from a list of phrases in a specific order as part of a game. For example, content presentation rules can be used to present phrases in a specific order as part of a scavenger hunt game.

In a specific implementation, content presentation rules include instructions for use in selectively displaying an advertisement to a user through the customizable display system 404. In being used in selectively displaying advertisements, as indicated by content data, to users, content presentation rules can specify when to display an advertisement to a user. For example, content presentation rules can specify to display an advertisement for a specific entity, when a user is located next to a store of the entity. In another example, content presentation rules can specify to display an advertisement pseudo-randomly, after a specific message or indicia is displayed to a user, or after a specific number of messages or indicia have been displayed to a user.

In a specific implementation, content presentation rules and content is specific to a persona of a user or otherwise associated with a persona of a user. A persona of a user is a user group a user has been or can be divided into based on market segmentation variables. Market segmentation variables include demographic, geographic, psychographic, behavioristic variables. For example, values of market segmentation variables can include an ethnicity and an age of a user. In another example, values of market segmentation variables can include activities a user likes performing, wants to perform, or has performed. A user group users can be segmented into can include only one user or a plurality of users. In being specific to a persona of a user, content presentation rules can be applied according to the persona of the user. For example, content presentation rules for users living in a region can be applied to a user if it is determined the user lives in the region. In another example, content presentation rules can specify displaying certain advertisements to a user if the user is a male living within a certain region. In another example, advertisements can only be presented to users living within a specific region.

In a specific implementation, content defines, at least in part, a persona based on the subject matter of a the content. For example, if content includes quotes from a specific television show, then the content can define a persona including a follower of the specific television show. A user can be mapped to a persona defined by content. For example, if a user utilizes content including quotes from a specific television show, then the user can be mapped to a persona defined by the specific television show. Personas defined by content can be used to selectively provide content to a user for rendering at a customizable display system. For example, if a user is mapped to a persona defined by a specific television show, then other content associated with the specific television show or a related television show can be provided to the user based on the mapping of the user to the persona defined by the specific television show.

In a specific implementation, content presentation rules include instructions for use in facilitating promotions or the giving, potentially for free, of goods or services. In facilitating promotions or the giving of goods or services, the content presentation rules can specify when to give a user a promotion, or give a user goods or services. For example, the content presentation rules can specify to pseudo-randomly award a free drink to a user. Further, in facilitating promotions or the giving of goods or services, the content presentation rules can specify to display an indicator, as represented by content data, of the promotion or won goods or services to a user. Additionally, the content presentation rules can specify notifying an entity or system for provisioning won goods or services to actually provision the awarded goods or services. For example, content presentation rules can specify instructing a company to send an electronic gift certificate to a user. Content presentation rules can set time limits on the giving of promotions, goods, or services. For example, content presentation rules can specify offering a user a promotion only once daily.

In a specific implementation, the customizable display system 404 includes a display affixed to a window of a novelty device. In various implementations, the window is colored to give the appearance the window provides a view to an interior reservoir containing a liquid. A display of the customizable display system 404 can be an applicable digital display, such as an LED display. In various implementations, the customizable display system 404 is configured to use a backlight of a display or edge light source to cause a message displayed on the display to gradually fade into and out of the display. The color of the backlight or edge light source can be varied and controlled by the CPU. As a result, a user feels as if there is a die encased in a liquid chamber in the device.

In a specific implementation, the customizable display system 404 is self-powering by utilizing a self-contained energy generator. Depending upon implementation-specific or other considerations, the customizable display system 404 can include a movement activated electrical generator. The movement activated electrical generator functions according to an applicable motion charger for creating electricity as it is moved. As a result, when a user manipulates a novelty device including the customizable display system 404, electricity is generated that can be used to power the customizable display system 404. Further depending upon implementation-specific or other considerations, the customizable display system includes a solar electrical generator. A solar electrical generator functions according to an applicable generator for generating power using sunlight. In various implementations, the customizable display system 404 includes a battery for storing generated electricity, a thermo-electric generator, radio frequency energy harvesting circuits to gather radio frequency energy broadcasted by devices like WiFi routers, cell phones, and AM/FM radio stations.

In a specific implementation, the customizable display system 404 is battery powered. A battery used to power the customizable display system 404 can be rechargeable or disposable. A novelty device utilizing the customizable display system 404 can include a battery terminal that a user can utilize to couple and decouple a battery to the customizable display system 404.

In a specific implementation, the customizable display system 404 includes a wireless interface through which the customizable display system 404 can send and receive data. A wireless interface of the customizable display system 404 can be an applicable interface for establishing a wireless communication channel, e.g. a Bluetooth® interface. A wireless communication channel can be used to send interaction data from the customizable display system 404. For example, if a user shakes the customizable display, then interaction data indicating the user shook the customizable display system 404 can be sent from the customizable display system 404 using a wireless interface. Further, in various implementations, the customizable display system 404 can receive presentation instructions through a wireless interface. For example, the customizable display system 404 can receive presentation instructions through a wireless interface indicating to display a specific message at the customizable display system 404.

In a specific implementation, the customizable display system 404 includes an orientation sensor. An orientation sensor is configured to determine if the customizable display system 404 or a novelty device integrating the customizable display system 404 has been manipulated to change its orientation and subsequently to cause the customizable display system 404 to display a message or indicia or change a previously displayed message or indicia to another message or indicia. For example, if the customizable display system 404 or a novelty device integrating the customizable display system 404 are turned over, then the orientation sensor can sense that the orientation of the customizable display system 404 or the novelty device integrating the customizable display system 404 has been changed. An orientation sensor, included as part of the customizable display system 404, can be used to generate interaction data, which can be provided to an applicable system for use in managing rendering of content at the customizable display system 404.

In a specific implementation, the customizable display system 404 includes environmental sensors for determining environmental conditions of the environment surrounding the customizable display system 404 or a novelty device integrating the customizable display system 404. Environmental conditions, as indicated by environmental conditions data, can include environmental characteristics of an environment around the novelty device. Example environmental characteristics include, characteristics of a user operating a novelty device with the integrated customizable display system 404, a surrounding temperature of the novelty device, a surrounding pressure of the novelty device, a date, a time of day, and a location of a novelty device with the integrated customizable display system 404. For example, environmental surroundings can include electrical properties of the skin of a user of a novelty device with the integrated customizable display system 404. In various implementations, the customizable display system 404 is configured to display messages or indicia according to environmental conditions detected by environmental sensors. For example, if environmental sensors determine that a surrounding temperature has increased above a threshold value, then the customizable display system 404 can display the message “It is hot in here.” In another example, if environmental sensors determine that air pollution in the surrounding area has increased above a threshold value, then the customizable display system 404 can display the message “Stay indoors.”

In a specific implementation, the customizable display system 404 includes an electroacoustic transducer that converts electrical signals into audio sounds. An electroacoustic transducer can generate sounds according to content presentation rules. For example, if content presentation rules specify to reproduce specific sounds when a word is displayed through the customizable display system 404, then an electroacoustic transducer can reproduce the specific sounds when the word is displayed. In various implementations, an electroacoustic transducer can use interaction data in reproducing sounds. Further, in various implementations, an electroacoustic transducer can reproduce a sound according to environmental conditions detected by environmental sensors. For example, if environmental sensors determine that a surrounding temperature has increased above a threshold value, then an electroacoustic transducer can reproduce the sound of sizzling food.

In a specific implementation, the customizable display system 404 or a novelty device integrated with the customizable display system 404 includes a physical content control switch. A physical content control switch includes necessary hardware components that allows a user to control reproduction of content at the customizable display system 404 using the switch. A user can utilized a physical content control switch to switch between different content actually rendered at the customizable display system 404. For example, if a customizable display system 404 is operating to reproduce content from a first list of messages and user activates a physical content control switch, then the customizable display system can begin to operate to reproduction content from a second list of messages in response to the activation of the switch.

The customizable message provisioning system 406 functions to manage a customizable display system in presenting customized messages or indicia. All or portions of the customizable message provisioning system 406 can be implemented on or otherwise as part of a novelty device integrated with a customizable display system. In managing a customizable display system, the customizable message provisioning system 406 can communicate with the customizable display system over a wired or wireless communication channel to control the display of customized messages or indicia. For example, the customizable message provisioning system 406 can communicate with a customizable display system using Bluetooth®. Additionally, the customizable message provisioning system 406 can be implemented as part of a native application or a web based application. For example, the customizable message provisioning system 406 can be a native application residing on a novelty device incorporating a customizable display system or the customizable display system itself.

In a specific implementation, the customizable message provisioning system 406 functions to maintain content data. The customizable message provisioning system 406 can provide maintained content data to an applicable system for rendering content, such as the customizable display systems described in this paper. The customizable message provisioning system 406 can maintain content data based on input receive from a user. For example, a user can input a list of customized messages to display, and the customizable message provisioning system 406 can generate content data indicating the list of customized messages. In another example, an advertiser can input an advertisement to display, and the customizable message provisioning system 406 can generate content data indicating the advertisement to display.

In a specific implementation, the customizable message provisioning system 406 functions to generate content data based on external sources. External sources can include sources related to a user or unrelated to a user. For example, external sources can include a social media profile of a user. In another example, external sources can include a search engine. In another example, the customizable message provisioning system 406 can determine from a search engine trending search terms and include the trending search terms in content data. In various implementations, the customizable message provisioning system 406 can limit or modify indicia or script that a user inputs according to either or both the size of the indicia or script or a size of a face that will include the indicia or script. For example, an application can remove words from a message input by a user to ensure that the message can fit on a display.

In a specific implementation, the customizable message provisioning system 406 functions to generate and send presentation instructions to a customizable display system, for use in controlling rendering of content. Presentation instructions include an instruction render content, e.g. to display a customized message or indicia. For example, the customizable message provisioning system 406 can send a presentation instruction to display a riddle at a customizable display system, and the customizable display system can display the riddle, using content data indicating the riddle, in response to receiving the presentation instruction. Presentation instructions can also include an instruction to reproduce a sound. For example, if content presentation rules indicate to reproduce a sound of sizzling food when a temperature, as indicated by environmental conditions data, reaches above a threshold temperature, then the customizable message provisioning system 406 can send a presentation instruction indicating to reproduce the sound of sizzling food.

In a specific implementation, the customizable message provisioning system 406 functions to generate and send presentation instructions to a customizable display system based on input received from a user. For example, a user can input to display a customized message, and the customizable message provisioning system 406 can generate and send presentation instructions indicating to display the customized message. For example, the customizable message provisioning system 406 can receive input from a user to display a message of “it is hot,” and subsequently generate and send a presentation instruction indicating to display the message “it is hot,” to an applicable system for rendering content, such as the customizable display systems described in this paper.

In a specific implementation, the customizable message provisioning system 406 functions to maintain content presentation rules for controlling content rendering using a customizable display system. As part of maintaining content presentation rules, the customizable message provisioning system 406 can maintain content presentation rules data indicating content presentation rules. The customizable message provisioning system 406 can maintain content presentation rules according to received user input. For example, a user who inputs a list of messages to display can specify an order in which to display the messages. Additionally, the customizable message provisioning system 406 can maintain content presentation rules absent instruction from a user. For example, the customizable message provisioning system 406 can set a display order of messages in a list as pseudo-random.

In a specific implementation, the customizable message provisioning system 406 functions to generate and send presentation instructions to a customizable display system according to content presentation rules. For example, if content presentation rules indicate to display a new specific message when a user shakes a customizable display system or a novelty device integrating the customizable display system, and the user actually shakes the customizable display system, then the customizable message provisioning system 406 can send a presentation instruction to the customizable display system indicating to present the new specific messaged. In another example, if content presentation rules indicate to render a sound of sizzling food when a temperate at a customizable display system increases above a threshold temperature, and the temperature increases above the threshold temperature, then the customizable message provisioning system 406 can send a presentation instruction indicating to reproduce the sound of sizzling food at the customizable display system.

In a specific implementation, the customizable message provisioning system 406 functions to receive either or both interaction data and environmental conditions data. For example, the customizable message provisioning system 406 can receive interaction data from orientation sensors integrated as part of a customizable display system. In another example, the customizable message provisioning system 406 can receive environmental conditions data from environmental systems integrated as part of a customizable display system.

In a specific implementation, the customizable message provisioning system 406 functions to generate and send presentation instructions based on either or both of received environmental conditions data and interaction data. For example, if environmental conditions data indicates a temperature at a customizable display system 404 has risen above a threshold temperature, then the customizable message provisioning system 406 can generate presentation instructions indicating to display a message of “It is hot in here.” In generating and sending presentation instructions based on either or both of received environmental conditions data and interaction data, the customizable message provisioning system 406 can generate and send the presentation instructions according to content presentation rules. For example, if content presentation rules indicate to send presentation instructions indicating to display a specific message after a user shakes a customizable display system, and interaction data indicates the user has shook the customizable display system, then the customizable message provisioning system 406 can send presentation instructions indicating to display the specific message.

In a specific implementation, the customizable message provisioning system 406 functions to manage rendering of content on a customizable display system according to input from a primary user. For example, a primary user can specify that only input from certain users is to be followed when generating and sending presentation instructions. In another example, a primary user can specify that only input from certain users is to be followed when maintain content presentation rules or content data. A primary user can include an owner of a novelty device integrated with a customizable display system.

In a specific implementation, the customizable message provisioning system 406 functions to send data to a customizable display system that is used to recognize the customizable message provisioning system 406. For example, the customizable message provisioning system 406 can send a code to a customizable display system that is used to recognize the customizable message provisioning system 406. Further in the example, the customizable display system can send an acknowledgment that the code matches a code at the customizable display system, thereby performing a hand shake like authentication. As a result, the chances of rogue devices connecting to a customizable display system and corrupting the customizable display system are reduced.

In an example of operation of the example system shown in FIG. 4, the customizable display system 404 receives content data and for use in controlling display of customized messages at the customizable display system 404. In the example of operation of the example system shown in FIG. 4, the customizable message provisioning system 406 receives interaction data from the customizable display system 404 based on user interaction with the customizable display system 404. Further, in the example of operation of the example system shown in FIG. 4, the customizable message provisioning system 406 sends presentation instructions for controlling presentation of the customized messages based on the received interaction data.

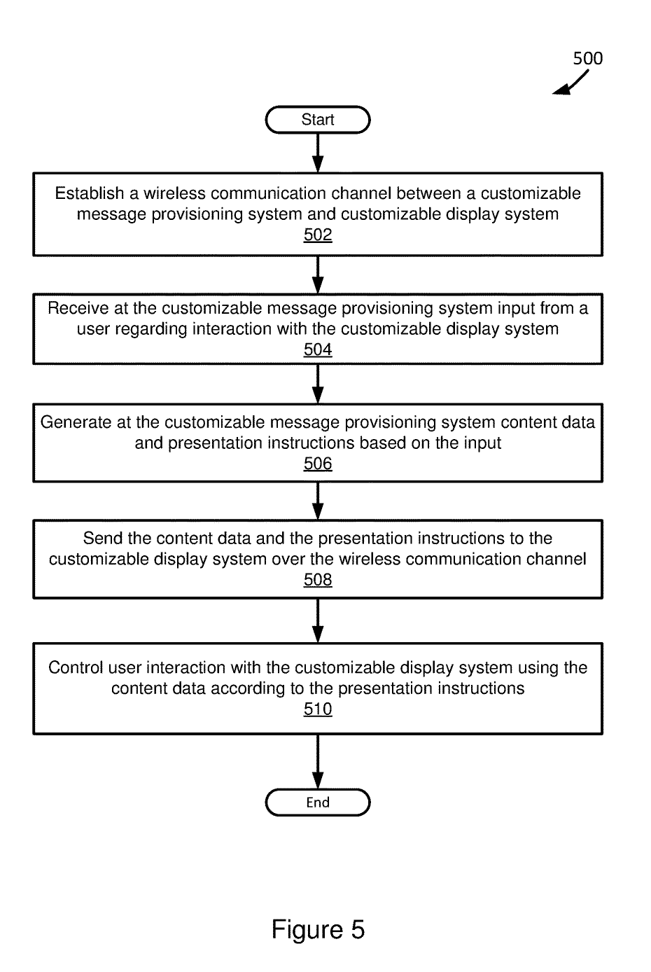

FIG. 5 depicts a flowchart 500 of an example of a method for controlling a customizable display system integrated as part of a novelty device. The flowchart 500 begins at module 502 where a wireless communication channel is established between a customizable message provisioning system and a customizable display system integrated as part of a novelty device. An applicable wireless communication channel can be established using applicable wireless interfaces, e.g. Bluetooth® interfaces.

The flowchart 500 continues to module 504, where input from a user regarding interaction with the customizable display system is received at the message provisioning system. Depending upon implementation-specific or other considerations, input can be received from a plurality of user or from a single user, e.g. a primary user. Input can indicate messages to display, sounds to reproduce, and/or interaction control conditions for displaying messages or reproducing sounds.

The flowchart 500 continues to module 506, where content data and presentation instructions are generated at the customized message provisioning system based on the input received at module 504. For example, if input indicates to display the phrase “it is hot,” when a surrounding temperature exceeds a threshold temperature, then content data can be created to display the phrase “it is hot,” and presentation instructions can be generated specifying to display the phrase when the surrounding temperature exceeds the threshold temperature.

The flowchart 500 continues to module 508, where the content data and the presentation instructions are sent to the customizable display system over the wireless communication channel. After being received at the customizable display system, the content data and the presentation instructions can be saved at the customizable display system for use in operation of the customizable display system integrated as part of the novelty device.

The flowchart 500 continues to module 510, where user interaction with the customizable display system and the novelty device is controlled according to the presentation rules using the content data. In various implementations, in controlling user interaction, message or indicia can be displayed on a display of the customizable display system when a user changes the orientation of the customizable display system and/or the novelty device. Further, in various implementations, in controlling user interaction, a sound can be reproduced by the customizable display system when a user changes the orientation of the customizable display system and/or the novelty device.

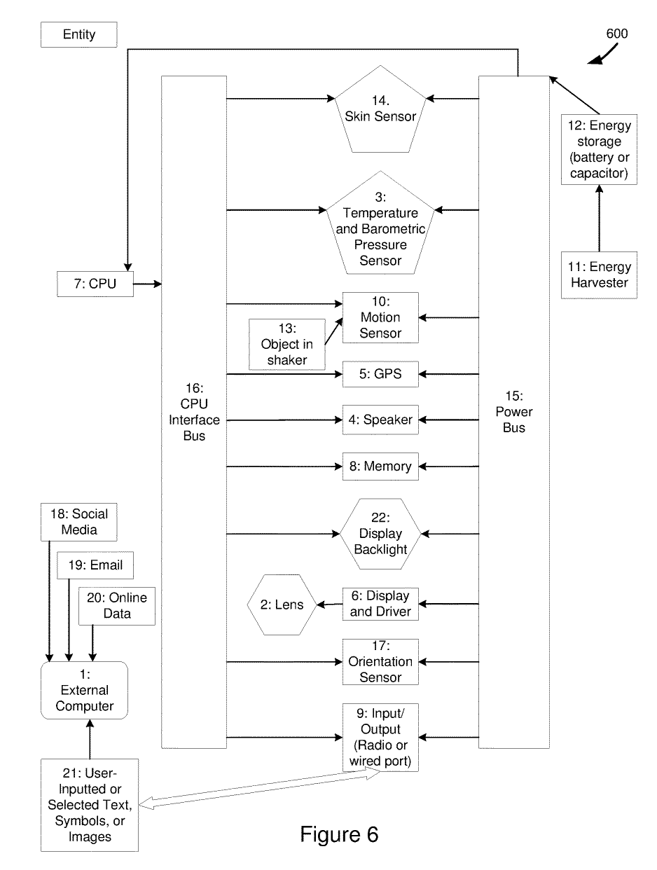

FIG. 6 depicts a diagram 600 of an example of a customizable message provisioning system and a customizable display system. The message provisioning system and the customizable display system in the example system shown in FIG. 6 can functions according to the message provisioning systems and the customizable display systems described in this paper. The customizable display system in the example system shown in FIG. 6 can be integrated as part of the novelty devices described in this paper.

In a specific implementation, the user utilizes an external computer 1 to input messages, characters, symbols, and numbers that can be displayed on the device display 6. The external computer 1 can function according to the computer systems described in this paper. The external computer 1 contains or accesses software that limits the amount of text or symbols to ensure that the inputted characters and symbols will fit on the display 6 within the device. The external computer 1 contains or accesses software that adjusts the graphical resolution of images to ensure that the images will fit on the display 6 within the device. The external computer 1 can receive text, symbols, and graphics sent to it by or extracted from social media 18 services, such as Twitter® and Facebook®, e-mail 19, online data 20, such as databases of song lyrics, and user inputted or selected text, symbols, or images 21. The external computer 1 can automatically extract text, symbols, and graphics from social media services triggered by a mention of certain names, the users past social media viewing history, and an assessment of trending topics. The external computer 1 can automatically provision and assign new labels (e.g., Twitter® hashtags) and apply them to social media services that it extracts.

The external computer 1 can connect to an online marketplace where a user can upload text, symbols, or images suitable for display on the device. At the online marketplace, the user can use the external computer 1 to purchase text, symbols, or images suitable for permanent or temporary display on the device. At the online marketplace, the user may choose to rent rather than purchase text, symbols, or images suitable for display on the device and such text, symbols, or images will be accompanied by an automatic deletion trigger that instructs the device to delete such text, symbols, or images after a certain date or after being displayed a certain number of times.

In a specific implementation, using the external computer 1, a user is able to assign probabilities of occurrence to each set of characters or symbols to be transmitted to the device. The software on or accessed by the external computer 1 can ensure that the sum of the probabilities selected total one hundred percent. The user may also assign certain sets of characters and sounds to play when the device senses a particular temperature range, barometric pressure range, or the electrical properties of the skin of the person holding the device. The device may automatically assign an equal probability of occurrence to each set of characters or symbols. The device may also interpret the meaning of each set of characters or symbols to be displayed and determine in which contexts it should be displayed.

In a specific implementation, using the external computer 1, a user is able to upload or select a series of sounds to be played when the device is shaken. The user can choose these sounds from a list contained within the software contained within or accessed by the external computer 1, or the user may upload sounds to the memory 8. The software can automatically screen any uploaded sounds to ensure that they are of the proper duration and format to be played by the device.

In a specific implementation, a user activates the device by shaking it, which moves the object in the shaker 13 and develops electric power through the energy harvester 11 or an external method of charging the energy storage 12. The electricity developed in the energy harvester 11 can be stored in the energy storage 12 and trickled into the CPU 7. The CPU 7 can load an operating program from the memory 8. The CPU 7 can instruct the input/output module 9 to listen for a signal from the external computer 1. The CPU 7 can communicate via the CPU interface bus 16 to interface with the skin sensor 14, temperature and barometric pressure sensor 3, motion sensor 10, GPS 5, speaker 4, memory 8, display and driver 6, input/output 9, and orientation sensor 17.

In a specific implementation, the external computer 1 transmits a unique code that matches a code in the device's memory 8 in order for the external computer 1 to be recognized by the device. If the device recognizes the external computer 1, then the device will transmit a signal of recognition (a handshake) through the input/output 9 back to the external computer 1.

In a specific implementation, if the external computer 1 is recognized by the device with a handshake, the external computer 1 transmits and the device receives sets of characters and symbols, each of which may have a probability of occurrence assigned, and sounds or symbols representing a particular sound, and stores them in the memory 8. For sound files stored in the memory 8, the external computer 1 can only transmit a code selecting a particular sound file, rather than transmit a new sound file to the device.

In a specific implementation, a user activates the device by shaking it, which moves the object in the shaker 13 and develops electric power through the energy harvester 11. The electricity developed in the energy harvester 11 can be stored in the energy storage 12 and trickled into the CPU 7. The CPU 7 can load an operating program from the memory 8. The operating program can cause the CPU 7 to select a discrete set of characters and symbols to be displayed on the display 6, which is visible to users through the lens 2. The selection of which set of characters and symbols to be displayed is driven by the probabilities downloaded from the external computer 1 or through application of a random number generator program. The power from the energy storage 12 can be transmitted via the power bus 15 to the display backlight 22, CPU 7, CPU interface bus 16, skin sensor 14, temperature and barometric pressure sensor 3, motion sensor 10, GPS 5, speaker 4, memory 8, display and driver 6, input/output 9, and orientation sensor 17.

In a specific implementation, the device can show certain phrases or play certain sounds based on the proximity of the device to certain GPS coordinates, as measured by the GPS 5 or GPS data from the External computer 1 to which it connects. The device can show certain phrases or play certain sounds based on the temperature or barometric pressure, as measured by the temperature and barometric pressure sensor 3. Further, the device can show certain phrases or play certain sounds based on the electrical properties of the skin of the person holding the device, as measured by the skin sensor 14.

In a specific implementation, the orientation sensor 17 is used to determine whether new text or symbols should be displayed when the device is moved. If the orientation of the device (e.g., turning it upside down) changes, then the device can display new text or symbols on the display 6.

In a specific implementation, the lens 2 is colored to give the appearance that the device is full of colored liquid. The CPU 7 can use the display backlight 22 to enable the text/phrase/symbols/graphics to gradually fade into and out of the display with a user-selected color, where such fade makes it appear that there is a die encased in a liquid chamber in the device.

In a specific implementation, the device uses the GPS sensor 5, temperature and barometric pressure sensor 3, electrical properties of the skin of users 14, a date and time when it is shaken and the set of characters and symbols displayed and sounds played. This information is stored in the memory 8 and can be communicated to the external computer 1 through the input/output module 9.

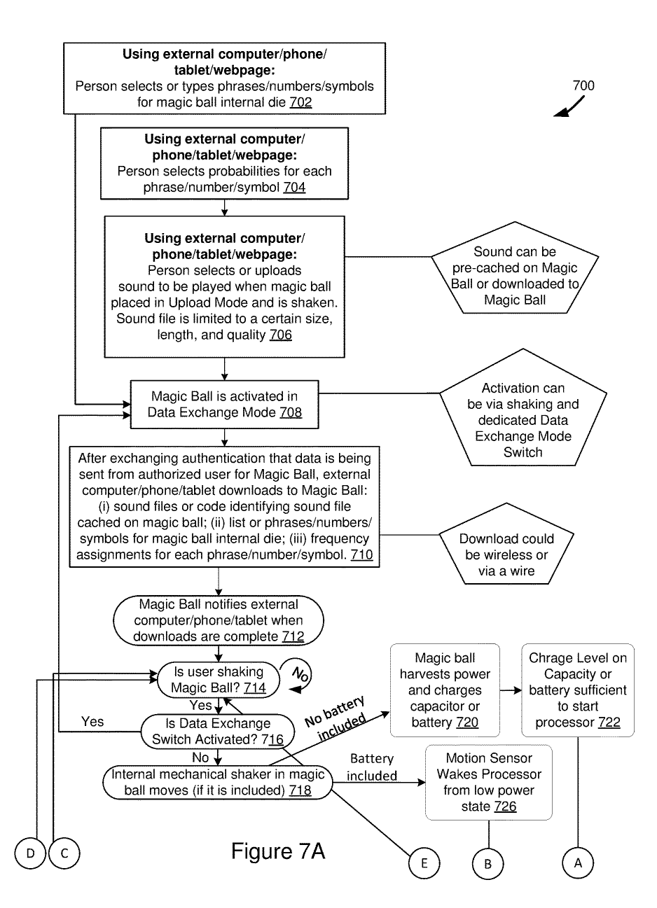

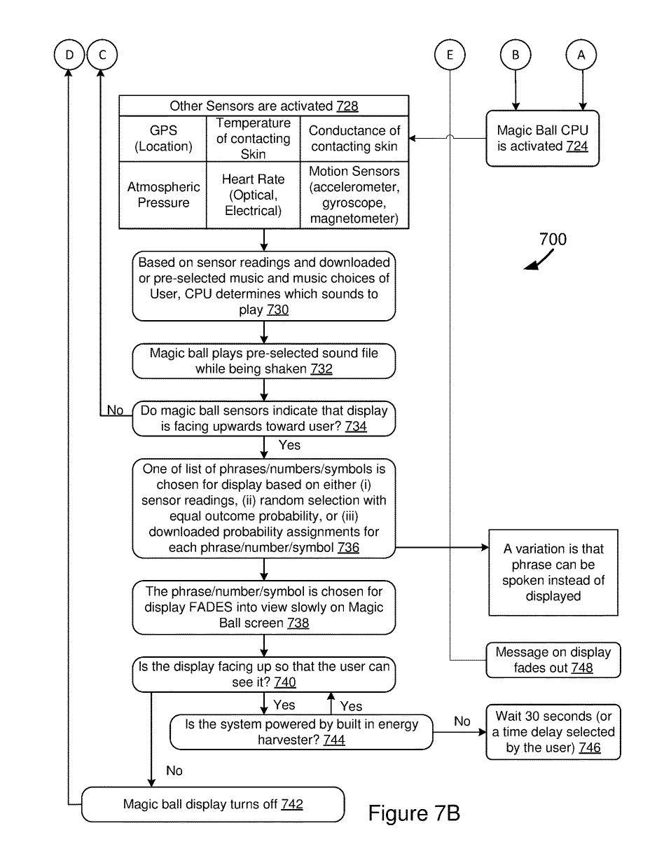

FIGS. 7A and 7B depict a diagram of a flowchart 700 of an example operation of a novelty device with an integrated customizable display system and a customizable message provisioning system. The flowchart begins at module 702, where a user selects or provides content to be reproduced at a customizable display system. An applicable engine for managing content to be reproduced at a customizable display system, such as the content gathering engines described in this paper, can receive user input regarding a selection or a providing of content to be reproduced at a customizable display.

The flowchart 700 continues to module 704, where a user selects probabilities for a phrase/number/symbol or other content capable of being reproduced by the customizable display system being reproduced. An applicable engine for managing content to be reproduced at a customizable display system, such as the content gathering engines described in this paper, can receive user input regarding probabilities content can be reproduced.

The flowchart 700 continues to module 706, where a user selects or uploads sounds to be played, as part of the customizable display system reproducing content. An applicable engine for managing content to be reproduced at a customizable display system, such as the content gathering engines described in this paper, can receive user input regarding a selection or content data of sounds to be played as part of the customizable display system reproducing content. Content data used reproduce a sound can be pre-loaded on the custom display system or sent to the custom display system.

The flowchart 700 continues to module 708, where a novelty device integrated with the customizable display system is activated in a data exchange mode.

The flowchart 700 continues to module 710, where after authentication of the novelty device including the customizable display system, content data is sent to the customizable display system by an external system, such as the customized content reproduction management systems described in this paper, in certain implementations. Content data can be sent to the customizable display system by an external system over either a wired or wireless connection.

The flowchart 700 continues to module 712, where the customizable display system is configured to notify the external computers when it has received the content data and completed downloading of the content data. An applicable system for managing content capable of being reproduced at the customizable display system, such as the customized content maintenance systems described in this paper, can notify an external compute when it has received the content data and completed downloading of the content data.

The flowchart 700 continues to module 714, where it is determined if a user is physically manipulating the novelty device. For example, it can be determined whether the user is shaking the novelty toy. Whether a user is physically manipulating the novelty device can be determined based on received interaction data by an applicable system for determining whether the user is physically manipulating the novelty device, such as the customized content reproduction management systems described in this paper.

If it is determined the user is physically manipulating the novelty device, at module 714, then the flowchart 700 continues to module 716, where it is determined if a data exchange switch is activated. An applicable system for managing content capable of being reproduced at the customizable display system, such as the customized content maintenance systems described in this paper, can determine if a data exchange switch is activated.

If it is determined that the data exchange switch is activated, then the flowchart 700 continues back to module 708. If it is determined that the data exchange switch is deactivated, then the flowchart 700 optionally continues to module 718, where an internal shaker, implanted as part of the customizable display system is moved.

The flowchart 700 continues to module 720, if the customizable display system lacks a user-provided or removable battery, where the customizable display system harvests electrical power using the shaker. In harvesting electrical power, either or both capacitors and batteries integrated as part of the customizable display system are charged until at module 722, where enough electrical power is collected to power a processor of the customizable display system. The flowchart 700 then continues to module 724, where a processor of the customizable display system is powered on. Alternatively, if the novelty device is integrated with a user-provided or removable battery, then the flowchart continues to modules 726 and back to module 724 where a processor of the customizable display system is woken up from a low power state and the processor is subsequently activated. At module 726, a processor of the customizable display system can operate at a low power state using electrical power supplied by the user-provided or removable battery.

The flowchart 700 continues to module 728, where other sensors of the customizable display system are activated. For example, environmental sensors of the customizable display system can be activated.

The flowchart 700 continues to module 730, where based on readings from the sensors, e.g. as indicated by environmental conditions data or interaction data, sounds are played by the customizable display system. Sounds can be played by the customizable display system using content data based on content presentation rules and the readings from the sensors. An applicable engine for managing reproduction of content by the customizable display system, such as the content reproduction direction engines described in this paper, can manage playing of sounds at the customizable display system based on readings from the sensors.

The flowchart 700 continues to module 732, where the customizable display system reproduces a pre-selected sound while the novelty device is being shaken by the user. An applicable engine for managing reproduction of content by the customizable display system, such as the content reproduction direction engines described in this paper, can manage reproduction of a pre-selected sound while the novelty device is being shaken by the user.

The flowchart 700 continues to module 734, where it is determined if the sensors of the customizable display system indicate that the customizable display system is facing forward towards the user. An applicable system for managing content reproduction at the customizable display system, such as the customized content reproduction management systems described in this paper, can determine if the customizable display system is facing forwards towards the user. Whether the customizable display system is facing forwards towards the user can be determined based on interaction data received from sensors.

If it is determined, at module 734, that the customizable display system is not facing forwards towards the user, then the flowchart 700 returns to module 714, where it is determined if the user is physically manipulating the novelty device. If it is determined, at module 734, that the customizable display system is not facing forwards towards the user, then the flowchart 700 continues to module 736, where a customized message of a list of customized messages is chosen for reproduction at the customizable display system. An applicable engine for managing content reproduction at the customizable display system, such as the content reproduction direction engines described in this paper, can choose a customize message of a list of customized messages to reproduce at the customizable display system.

The flowchart 700 continues to module 738, where the customized message is displayed at the customizable display system by fading the message into view. The customized message can be displayed at the customizable display system using content data in response to a presentation instruction.

The flowchart 700 continues to module 740, where it is determined if the customizable display system is facing towards the user. An applicable system for managing content reproduction at the customizable display system, such as the customized content reproduction management systems described in this paper, can determine if the customizable display system is facing towards the user.

If it is determined, at module 740, that the customizable display system is not facing forwards towards the user, e.g. where the user can see the display, then the flowchart 700 continues to module 742, where the customizable display system is powered off. If it is determined, at module 740, that the customizable display system is not facing forwards towards the user, the flowchart 700 continues to module 744, where it is determined if the customizable display system is operating using electrical power harvested using the shaker.

If it is determined, at module 744, that the customizable display system is not operating using electrical power harvested using the shaker, then the flowchart 700 continues to modules 746 and 748, where a specific amount of time is let to pass, e.g. thirty seconds, and the customized message displayed on the customizable display system fades until it is no longer displayed. The flowchart 700, after both modules 748 and 742 return back to module 714, where it is determined if the user is physically manipulating the novelty device.

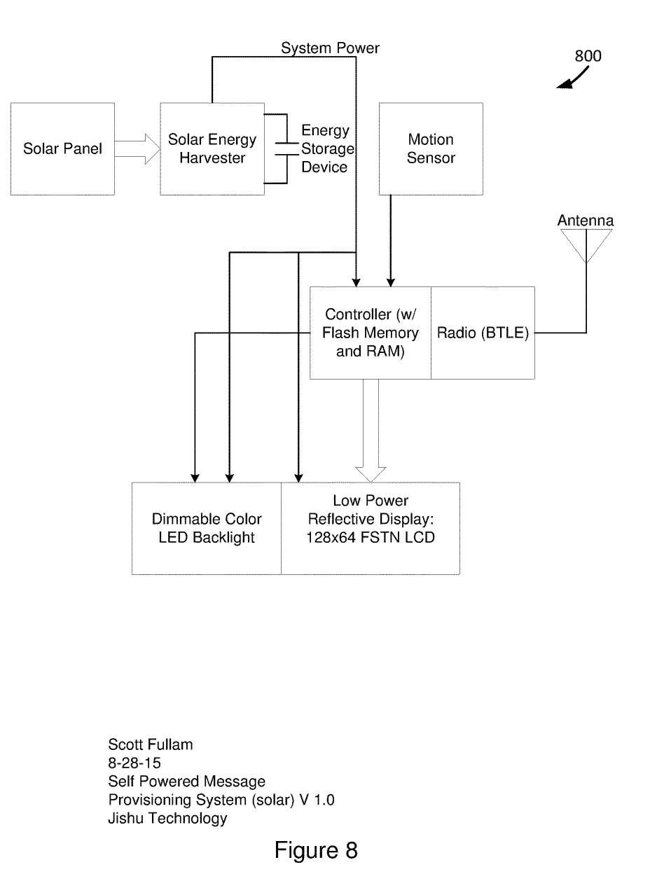

FIG. 8 depicts a diagram 800 of a solar powered customizable display system integrated with a novelty device.

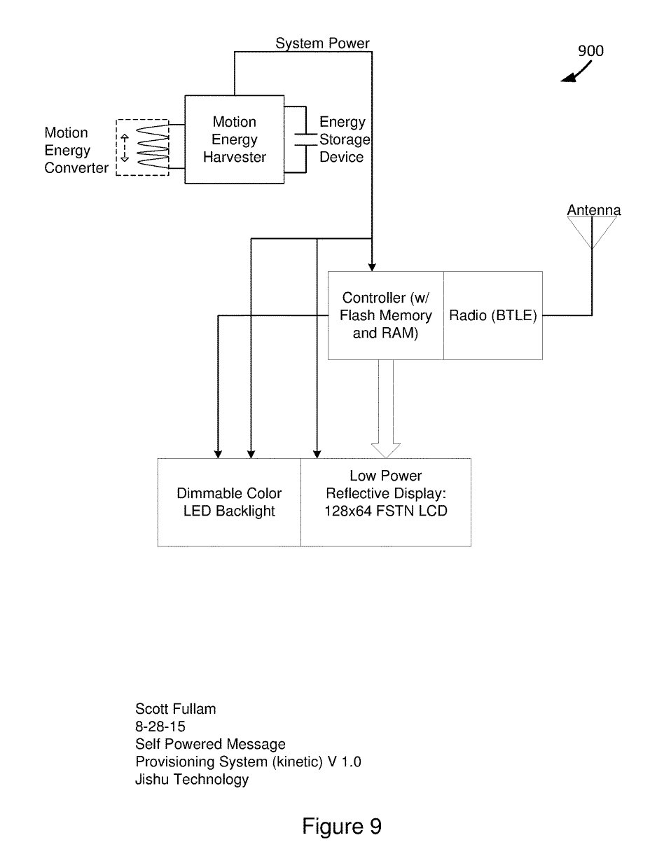

FIG. 9 depicts a diagram 900 of a movement activated self-powering customizable display system integrated with a novelty device.

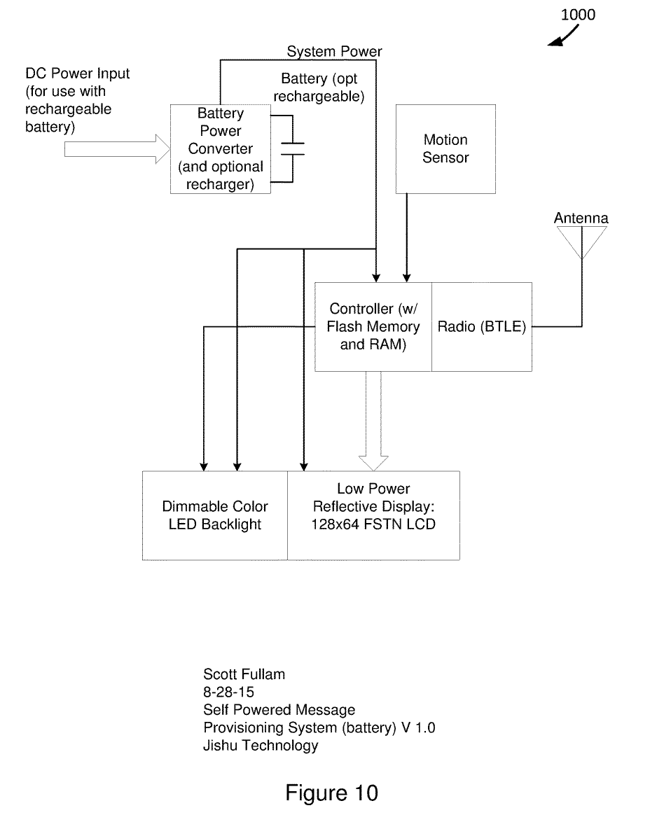

FIG. 10 depicts a diagram 1000 of a battery powered customizable display system integrated with a novelty device.

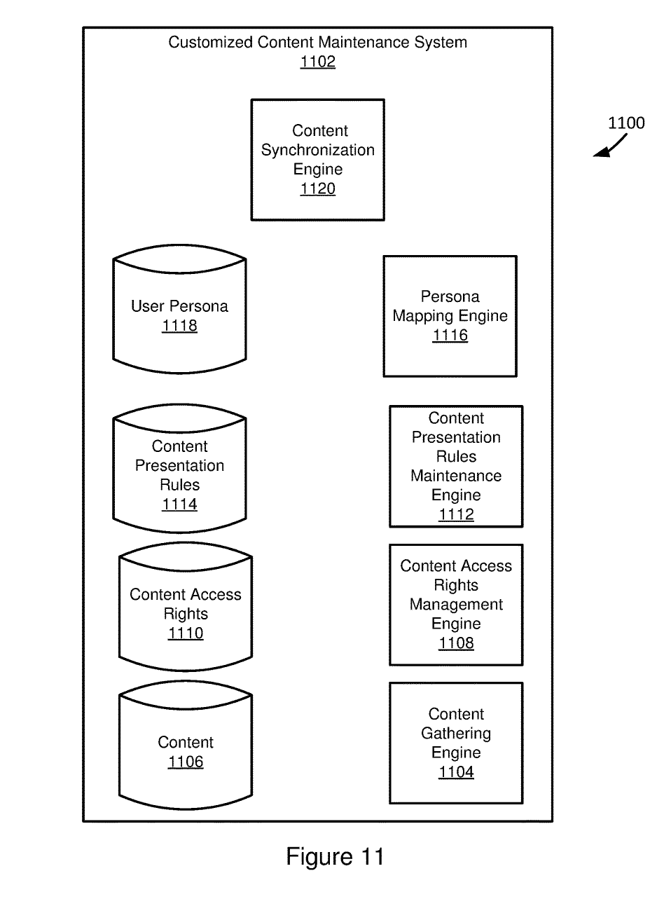

FIG. 11 depicts a diagram 1100 of a customized content maintenance system 1102. The customized content maintenance system 1102 functions to maintain content and associated rules for presenting such content on a customizable display system. All or portions of the customized content maintenance system 1102 can be integrated as part of an applicable system for managing reproduction of content through a customizable display system, such as the customizable message provisioning systems described in this paper. The customized content maintenance system 1102 can maintain content data for use in reproducing content for a user through a customizable display system. Additionally, the customized content maintenance system 1102 can maintain content rules for use in determining when and how to reproduce content for a user through a customizable display system.

The example customized content maintenance system 1102 shown in FIG. 11 includes a content gathering engine 1104, a content datastore 1106, a content access rights management engine 1108, a content access rights datastore 1110, a content presentation rules maintenance engine 1112, a content presentation rules datastore 1114, a persona mapping engine 1116, a user persona datastore 1118, and a content synchronization engine 1120. The content gathering engine 1104 functions to gather content for reproduction to a user through a customizable display system. Content gathered by the content gathering engine 1104 can include customized messages, indicia, or sounds. For example, the content gathering engine 1104 can generate a list of customized messages capable of being displayed on a customizable display system. In gathering content for reproduction to a user through a customizable display system, the content gathering engine 1104 can maintain content data. For example, the content gathering engine 1104 can generate content data used to reproduce a message or indicia at a customizable display system.

In a specific implementation, the content gathering engine 1104 functions to gather content based on input from users. For example, a primary user can provide to the content gathering engine 1104 a list of messages to display on a customizable display system, and the content gathering engine 1104 can generate content data including the list of messages, for use in reproducing the messages at the customizable display system. In utilizing users to gather content, the content gathering engine 1104 can function to crowd source the generation of content for reproduction by a customizable display system. For example, the content gathering engine 1104 can gather messages to display from a plurality of users and subsequently create a list of the messages for potential display on a customizable display system.

In a specific implementation, the content gathering engine 1104 functions to gather content from external sources. External sources can include sources related to a user or unrelated to a user. For example, external sources can include a social media profile of a user. In another example, external sources can include a search engine. In using a search engine to gather content, the content gathering engine 1104 can determine from the search engine trending search terms and generate content to include the trending search terms.

In a specific implementation, the content gathering engine 1104 functions to modify gathered content for reproduction by a customizable display system. In modifying gathered content, the content gathering engine 1104 can limit or modify indicia or script according to either or both the size of the indicia or script or a size of a face that will include the indicia or script. For example, the content gathering engine 1104 can remove words from a message input by a user to ensure that the message can fit on a display. Additionally, in modifying gathered content, the content gathering engine 1104 can remove indicia or words from gathered content. For example, the content gathering engine 1104 can remove offensive language from gathered content.

In a specific implementation, the content gathering engine 1104 functions to gather content from an applicable source for managing advertising, promotion, or giving away of products or services. For example, the content gathering engine 1104 can gather content data of a digital marketing firm managing advertisements for an entity providing goods or services. In another example, the content gathering engine 1104 can gather content indicating an offered promotion for a good or service, from an entity offering the good or service.

The content datastore 1106 functions to store content data. Content data stored in the content datastore 1106 can be maintained by an applicable engine for gathering content to be displayed at a customizable display system, such as the content gathering engines described in this paper. Additionally, content data stored in the content datastore 1106 can be provided to a customizable display system can be provided to the customizable display system for use in reproducing content for users, e.g. in response to presentation instructions. Further, content data stored in the content datastore 1106 can be associated with user personas. Specifically, content data can be associated with either or both specific user personas and specific users who have been mapped to user personas. For example content data can indicate specific content should be reproduced for users who live within a certain region.

The content access rights management engine 1108 functions to manage access rights to content capable of being reproduced through a customizable display system. In managing access rights to content, the content access rights management engine 1108 can generate or update content access rights data to indicate specific content a user has a right to perceive. For example, if a user has gained the right to have a list of messages displayed at a customizable display system utilized by the user, then the content access rights management engine 1108 can update content access rights data to indicate the user has a right to have the messages within the list displayed at the customizable display system.

In a specific implementation, the content access rights management engine 1108 functions to grant access rights to content capable of being reproduced through a customizable display system. In granting access rights to content, the content access rights management engine 1108 can sell the access rights to a user. For example, the content access rights management engine 1108 can sell to a user a right to have messages within a list of messages displayed at a customizable display system owned or otherwise operated by the user. Further, in granting access right to content, the content access rights management engine 1108 can reward the access rights to a user. For example, the content access rights management engine 1108 can reward to a user a right to have messages within a list of messages displayed at a customizable display system owned or otherwise operate by the user.

The content access rights datastore 1110 functions to store content access rights data. Content access rights data indicates users access rights to content capable of being reproduced through a customizable display system. For example, content access rights data can be updated to indicate a user has a right to reproduce specific content through a customizable display system owned or operated by a user. Content access rights data stored in the content access rights datastore 1110 can be maintained by an applicable engine for managing access rights to content capable of being reproduced through a customizable display system, such as the content access rights management engines described in this paper.

The content presentation rules maintenance engine 1112 functions to maintain content presentation rules for controlling reproduction of content through a customizable display system. In maintaining content presentation rules, the content presentation rules maintenance engine 1112 can generate or update content presentation rules data indicating content presentation rules. The content presentation rules maintenance engine 1112 can maintain content presentation rules absent input from a user or a controlling authority. For example, the content presentation rules maintenance engine 1112 can set a pseudo-random display order, as included as part of content presentation rules, for a list of messages absent input from a user or a controlling authority. Additionally, the content presentation rules maintenance engine 1112 can set an order in which to reproduce content and then set a pseudo-random display order. For example, the content presentation rules maintenance engine 1112 can set a display order for a list of customized messages and then set a command to pseudo-randomly select messages to display customized messages in the list of messages after all or a specific number of customized messages in the list have been displayed according to the display order.

In a specific implementation, the content presentation rules maintenance engine 1112 functions to maintain presentation frequencies for reproducing content, as included as part of content presentation rules. Presentation frequencies are frequencies at which to reproduce content by a customizable display system. The content presentation rules maintenance engine 1112 can set weighted presentation frequencies for different content. For example, the content presentation rules maintenance engine 1112 can set a presentation frequency of a first customized message in a list of customized messages at a value greater than a second customized message in the list to cause the first customized message to be reproduced more frequently than the second customized message.

In a specific implementation, the content presentation rules maintenance engine 1112 functions to maintain content presentation rules according to input received from a user. For example a user can provide to the content presentation rules maintenance engine 1112 specify a display order for messages in a provided list of customized messages capable of being displayed at a customizable display system. Further in the example, the content presentation rules maintenance engine 1112 can generate content presentation rules for the list of customized messages specifying to display the messages in the display order specified by the user.

In a specific implementation, the content presentation rules maintenance engine 1112 functions to maintain content presentation rules according to input received from an applicable source for managing advertising, promotion, or giving away of products or services. For example, the content presentation rules maintenance engine 1112 can generate content presentation rules specifying to present an advertisement of a product through a customizable display system at least once a day. In another example, the content presentation rules maintenance engine 1112 can generate content presentation rules specifying to give away a product to a user of a plurality of users within a specific region only once a day, e.g. by notifying the user utilizing a customizable display system.

In a specific implementation, the content presentation rules maintenance engine 1112 functions to associate content presentation rules with user personas. In associating content presentation rules with user personas, the content presentation rules maintenance engine 1112 can specify which content presentation rules to use for specific personas of users of a customizable display system. For example, if a user persona indicates a user lives within a specific region, then the content presentation rules maintenance engine 1112 can specify using content presentation rules for displaying advertisements of restaurants within the specific region to the user. In another example, if a user persona indicates a user is a male between the ages of twenty and twenty-five, can specify using content presentation rules that lead to display of advertisements at a faster rate than a normal rate.

The content presentation rules datastore 1114 functions to store content presentation rules data. Content presentation rules data stored in the content presentation rules datastore 1114 specifies content presentation rules used in controlling the reproduction of content at a customizable display system. Content presentation rules data stored in the content presentation rules datastore 1114 can be maintained by an applicable engine for maintaining content presentation rules used in controlling the reproduction of content at a customizable display system, such as the content presentation rules maintenance engines described in this paper. Content presentation rules data stored in the content presentation rules datastore 1114 can specify content presentation rules associated with a user persona. For example, content presentation rules indicated by data stored in the content presentation rules datastore 1114 can specify rules to use in reproducing content on a customizable display system to a user within a specific age range.

The persona mapping engine 1116 functions to map a user of a customizable display system to a persona. In mapping a user to a persona, the persona mapping engine 1116 can use information gathered from a customizable display system or a novelty device implementing the customizable display system. For example, if a user in utilizing a customizable display system or a novelty implementing the customizable display system is within a specific region, then the persona mapping engine 1116 can map the user to a persona defined to include people within the specific region. Additionally, in mapping a user to a persona, the persona mapping engine 1116 can use information gathered from an applicable information system, e.g. a social network of a user. For example, if a social network of a user indicates a user likes a music band popular within a specific age group of people, then the persona mapping engine 1116 can map the user to a persona defined to include people within the specific age group.

The user persona datastore 1118 functions to store user persona data. User persona data indicates specific users and personas to which they have been matched. User persona data stored in the user persona datastore 1118 can indicate a plurality of personas to which a user has been mapped. User persona data stored in the user persona datastore 1118 can be maintained by an applicable system for mapping users to personas for purposes of a managing reproduction of content to the users at a customizable display system, such as the persona mapping engines described in this paper.

The content synchronization engine 1120 functions to synchronize one or an applicable combination of content data, content access rights data, and content presentation rules data with an applicable external device. An example external device can include an applicable client device, e.g. a smartphone, or another novelty device integrated with a customizable display system. In synchronizing an applicable external device, the content synchronization engine 1120 can pair, using a wireless connection, the applicable external device with a novelty device integrated with a customizable display system. Additionally, in synchronizing with an applicable external device, the content synchronization engine 1120 can receive one or an applicable combination of content data, content access rights data, and content presentation rules data from an applicable external device. For example, the content synchronization engine 1120 can be used to wirelessly receive content data from another novelty device integrated with a customizable display. Additionally, in synchronization with an applicable external device, the content synchronization engine 1120 can send one or an applicable combination of content data, content access rights data, and content presentation rules data to an applicable external device. For example, the content synchronization engine 1120 can be used to wirelessly transmit content data to another novelty device integrated with a customizable display.

In an example of operation of the example customized content maintenance system 1102 shown in FIG. 11, the content gathering engine 1104 gathers content that can be reproduced at a customizable display system integrated as part of a novelty device. In the example of operation of the example system shown in FIG. 11, the content datastore 1106 stores content data indicating the content gathered by the content gathering engine 1104. Additionally, in the example of operation of the example system shown in FIG. 11, the content access rights management engine 1108 maintains access rights for users of the customizable display system to have the content reproduced through the customizable display system. In the example, operation of the example system shown in FIG. 11, the content access rights datastore 1110 stores contents access rights data indicating the access rights for the users of the customizable display system. Further, in the example of operation of the example system shown in FIG. 11, the content presentation rules maintenance engine 1112 maintains content presentation rules, as indicated by content presentation rules data stored in the content presentation rules datastore 1114, for use in controlling reproduction of content at the customizable display system.

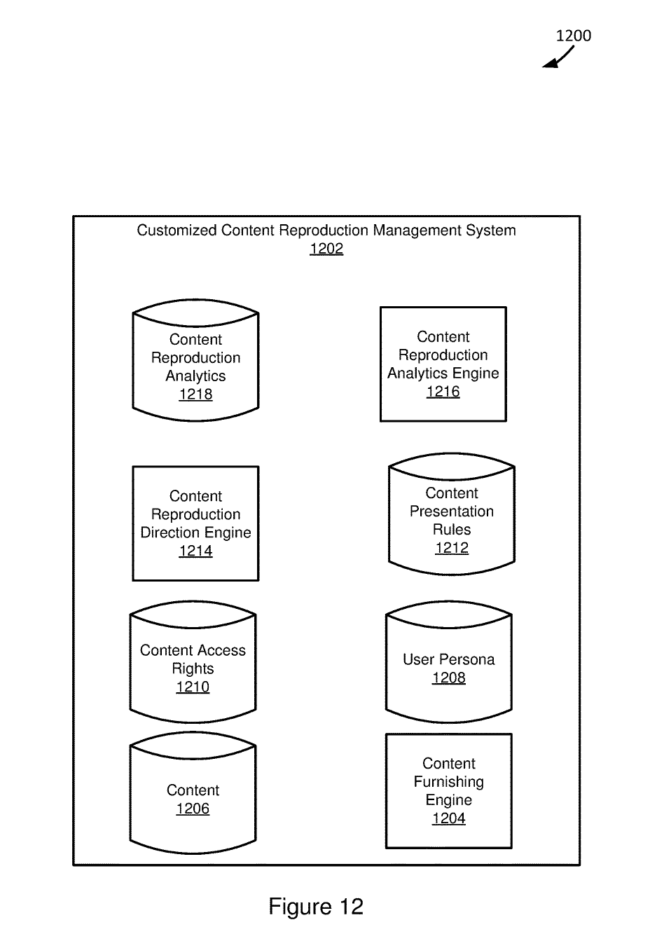

FIG. 12 depicts a diagram 1200 of an example of a customized content reproduction management system 1202. The customized content reproduction management system 1202 functions to manage reproduction of content through a customizable display system. All or portions of the customized content reproduction management system 1202 can be integrated as part of an applicable system for managing reproduction of content through a customizable display system, such as the customizable message provisioning systems described in this paper. In managing reproduction of content through a customizable display system, the customized content reproduction management system 1202 can send content data to the customizable display system for use by the display system in reproducing content, e.g. customized messages or indicia. Additionally, in managing reproduction of content through a customizable display system, the customized content reproduction management system 1202 can instruct a customizable display system to reproduce content by sending presentation instructions to the display system.

In a specific implementation, the customized content reproduction management system 1202 functions to receive either or both interaction data and environmental conditions data. The customized content reproduction management system 1202 can used either or both received interaction data and environmental conditions data to control reproduction of content at a customizable display system. For example, if received interaction data indicates a user has changed orientation of a customizable display system or a novelty device integrated with a customizable display system and content presentation rules dictate displaying a new message from a list of messages when the orientation of the customizable display system or the novelty device is changed by a user, then the customized content reproduction management system 1202 can cause the display system to reproduce the new message.

The example customized content reproduction management system 1202 shown in FIG. 12 includes a content furnishing engine 1204, a content datastore 1206, a user persona datastore 1208, a content access rights datastore 1210, a content presentation rules datastore 1212, a content reproduction direction engine 1214, a content reproduction analytics engine 1216, and a content reproduction analytics datastore 1218. The content furnishing engine 1204 functions to provide content data to a customizable display system. Content data provided by the content furnishing engine 1204 to the customizable display system is used by the customizable display system to reproduce the content at the customizable display system. All content data provided by the content furnishing engine 1204 to a customizable display system does not necessarily have to be used by the customizable display system in reproducing content. For example, the content furnishing engine 1204 can provide to a customizable display system content data for use in reproducing a plurality of customized messages within a list, while the customizable display system might only reproduce a subset of the plurality of customized messages within the list.

In a specific implementation, the content furnishing engine 1204 functions to selectively provide content data to a customizable display system. In selectively providing content data to a customizable display system, the content furnishing engine 1204 can select specific content data to provide to a customizable display system, and subsequently provide the selected specific content data to the customizable display system. The content furnishing engine 1204 can selectively provide content data to a customizable display system based on user input. For example a user of a customizable display system can specify they want to display customized messages, e.g. messages made by the user, in a list at the customizable display system, and the content furnishing engine 1204 can provide content data used to reproduce the customized messages to the customizable display system. Additionally, the content furnishing engine 1204 can select content to provide to a customizable display system based on a persona to which a user associated with the customizable display system has been mapped. For example, if specific content is associated with males between the ages of twenty and twenty-five and a user of a customizable display system is a male between the ages of twenty and twenty-five, then the content furnishing engine can select and subsequently provide the specific content to the customizable display system.

In a specific implementation, the content furnishing engine 1204 presents categories of content to a user for use in selectively providing content data to a customizable display system. Categories of content can include personas associated with content or defined by content. In presenting categories of content to a user, the content furnishing engine 1204 can receive input regarding a selection of a category of content made by a user and subsequently selectively provide content within the selected category or other categories based on the selected category. For example, a user can select a content category of a specific genre of music, and the content furnishing engine 1204 can provide content within the specific genre of music to a customizable display system.

In a specific implementation, the content furnishing engine 1204 functions to select content to provide to a customizable display system based on content access rights. The content furnishing engine 1204 can select content data to provide to a customizable display system based on whether a user associated with the customizable display system has access rights to the content represented by the content data. For example, if a user has access rights to content, then the content furnishing engine 1204 can provide content data used in reproducing the content to a customizable display system. The content furnishing engine 1204 can provide content data to a customizable display system as soon as a user associated with the customizable display system gains access rights to content indicated by the content data. Alternatively, the content furnishing engine 1204 can provide content data to a customizable display system as the customizable display system requests access to content corresponding to the content data, for which a user associated with the customizable display system has gained access rights.

The content datastore 1206 functions according to an applicable datastore for storing content data, such as the content datastores described in this paper. Content data stored in the content datastore 1206 can be used by a customizable display system to reproduce content for a user. Additionally, content data stored in the content datastore 1206 can include personas associated with specific content. Personas associated with specific content, as indicated by content data stored in the content datastore 1206 can be used to selectively provide content data to customizable display systems, for use in reproducing content by the display systems.

The user persona datastore 1208 functions according to an applicable datastore for storing user persona data indicating personas to which specific users have been mapped, such as the user persona datastores described in this paper. User persona data stored in the user persona datastore 1208 can be maintained by an applicable engine for mapping users to personas according to market segmentation variables, such as the persona mapping engines described in this paper. Additionally, user persona data stored in the user persona datastore 1208 can be used to selectively provide content data to a customizable display system. For example, if specific content represented by specific content data is associated with a specific persona and a user of a customizable display system has been mapped to the specific persona, as indicated by user persona data stored in the user persona datastore 1208, then the specific content data can be provided to the display system based on the mapping.

The content access rights datastore 1210 functions according to an applicable datastore for storing content access rights data used in controlling reproduction of content at a customizable display system, such as the content access rights datastores described in this paper. Content access rights data stored in the content access rights datastore 1210 can be used to selectively provide content data to a customizable display system for reproduction by the display system. For example, only content data of content to which a user associated with a customizable display system has access rights, as indicated by content access rights data stored in the content access rights datastore 1210, can be provided to the customizable display system. Additionally, content access rights data stored in the content access rights datastore 1210 can be used to control reproduction of content at a customizable display system. Content access rights data stored in the content access rights datastore 1210 can be maintained by an applicable engine for maintaining content access rights used in reproducing content at a customizable display system, such as the content access rights management engines described in this paper.

The content presentation rules datastore 1212 functions according to an applicable datastore for storing content presentation rules data indicating content presentation rules for controlling reproduction of content at a customizable display system, such as the content presentation rules datastores described in this paper. The content presentation rules datastore 1212 can store content presentation rules data generated based on input by an applicable entity for controlling content presentation rules. For example, the content presentation rules datastore 1212 can store content presentation rules data generated based on input received from an entity responsible for managing advertisements of products. In another example, the content presentation rules datastore 1212 can store content presentation rules data generated based on input received from a user or entity who created content capable of being reproduced at a customizable display system. Content presentation rules data stored in the content presentation rules datastore 1212 can be maintained by an applicable engine for maintaining content presentation rules for controlling reproduction of content at a customizable display system, such as the content presentation rules maintenance engines described in this paper.

The content reproduction direction engine 1214 functions to control reproduction of content at a customizable display system. In controlling reproduction of content, the content reproduction direction engine 1214 can generate and provide presentation instructions to a customizable display system, for use by the customizable display system to reproduce content using content data. For example, the content reproduction direction engine 1214 can send to a customizable display system a presentation instruction indicating a specific message to display, and the customizable display system can display the specific message in response to the presentation instruction. Additionally, in controlling reproduction of content, the content reproduction direction engine 1214 can select content for a customizable display system to reproduce. For example, the content reproduction direction engine 1214 can pseudo-randomly select a customized message from a list of customized messages to be displayed at a customizable display system.

In a specific implementation, the content reproduction direction engine 1214 functions to control reproduction of content according to content presentation rules. For example if content presentation rules specify a specific starting message to display from a list of messages, then the content reproduction direction engine 1214 can generate and send a presentation instruction to a customizable display system indicating to display the specific starting message. Further in the example, if content presentation rules specify to pseudo-randomly select a next message from the list of messages to display, then the content reproduction direction engine 1214 can select a next message from the list pseudo-randomly and subsequently generate and send presentation instructions specifying to display the next message. In controlling reproduction of content according to content presentation rules, the content reproduction direction engine 1214 can control reproduction of advertisements at a customizable display. For example, if content presentation rules specify to display an advertisement after every four messages are reproduced, then the content reproduction direction engine 1214 can generate and send a presentation instruction to a customizable display system indicating to display a specific advertisement.

In a specific implementation, the content reproduction direction engine 1214 functions to control reproduction of content at a customizable display system based on user personas. In controlling reproduction of content based on user personas, the content reproduction direction engine 1214 can select content presentation rules to use in controlling reproduction of content at a customizable display system based on user personas of users associated with the customizable display system. For example, if a user of a customizable display system is a 30 year old male, then the content reproduction direction engine 1214 can utilize content presentation rules specifically associated with a persona including 30 year old males in controlling the reproduction of content at the customizable display system.

In a specific implementation, the content reproduction direction engine 1214 functions to control reproduction of content at a customizable display system based on either or both received interaction data and environmental conditions data. The content reproduction direction engine 1214 can use content presentation rules in controlling reproduction of content at a customizable display system based on either or both received interaction data and environmental conditions data. For example, if interaction data indicates a user has changed an orientation of a customizable display system or a novelty device integrating the system, e.g. shaken the novelty device, and content presentation rules indicate to display a new message in response to a changes of orientation of the customizable display system or device integrated it, then the content reproduction direction engine 1214 can cause the new message to be reproduced by the customizable display system. In another example, if environmental conditions data indicates a temperate at a novelty device integrating a customizable display system has risen to a certain temperature above a threshold temperature, and content presentation rules specify to display the message “It is hot” if the temperature at the novelty device rises above the threshold temperature, then the content reproduction direction engine 1214 can cause the customizable display system to display the message “It is hot.”

The content reproduction analytics engine 1216 functions to maintain content reproduction analytics of a customizable display system in reproducing content. Content reproduction analytics is represented by content analytics data and includes applicable data related to reproduction of content at a customizable display system. For example, content analytics can include what content is actually reproduced at a customizable display system, times at which content is reproduced, what content is not reproduced, what content is not selected for potentially being reproduced at a customizable display system, how often content is reproduced, user interactions with a customizable display system or a novelty device integrated with a customizable display system, and environmental conditions at a customizable display system or a novelty device integrated with a customizable display system. Content reproduction analytics can also indicate application information related to interaction of a user with a customizable display system or a novelty device integrated with a customizable display system, e.g. how often it is moved, locations it is moved to, and how a user actually interacts with it. Content reproduction analytics can be used to match people, e.g. through a social network platform. For example, if content reproduction analytics show two users react similarly in interacting with a novelty device integrating a customizable display system, then the two users can be matched or otherwise notified of their shared interactions.

The content reproduction analytics datastore 1218 functions to store content reproduction analytics data indicating content reproduction analytics of a customizable display system in reproducing content. Content reproduction analytics data stored in the content reproduction analytics datastore 1218 can be maintained by an applicable engine for maintaining content reproduction analytics of a customizable display system in reproducing content, such as the content reproduction analytics engines described in this paper. Content reproduction analytics data stored in the content reproduction analytics datastore 1218 can be used by an applicable entity to view content reproduction analytics of reproduction of content at a customizable display system. For example, an entity can view a number of times their advertisements were displayed to users through customizable display systems using content reproduction analytics data stored in the content reproduction analytics datastore 1218.

In an example of operation of the example system shown in FIG. 12, the content datastore 1206 functions to store content data of content capable of being reproduced at a customizable display system integrated as part of a novelty device. In the example of operation, the user persona datastore 1208 stores user persona data indicating a persona to which a user of the novelty device is mapped. Further, in the example of operation, the content furnishing engine 1204 selectively provides content data stored in the content datastore 1206 based on the persona to which the user of the novelty device is mapped. In the example of operation, the content presentation rules datastore 1212 stores content presentation rules for controlling reproduction of content by the customizable display system using the content data. Additionally, in the example of operation, the customized content reproduction management system 1202 receives interaction data indicating how a user has manipulated the novelty device. In the example of operation, the content reproduction direction engine 1214 controls the reproduction of content at the customizable display system based on how the user has manipulated the novelty device and according to the content presentation rules.

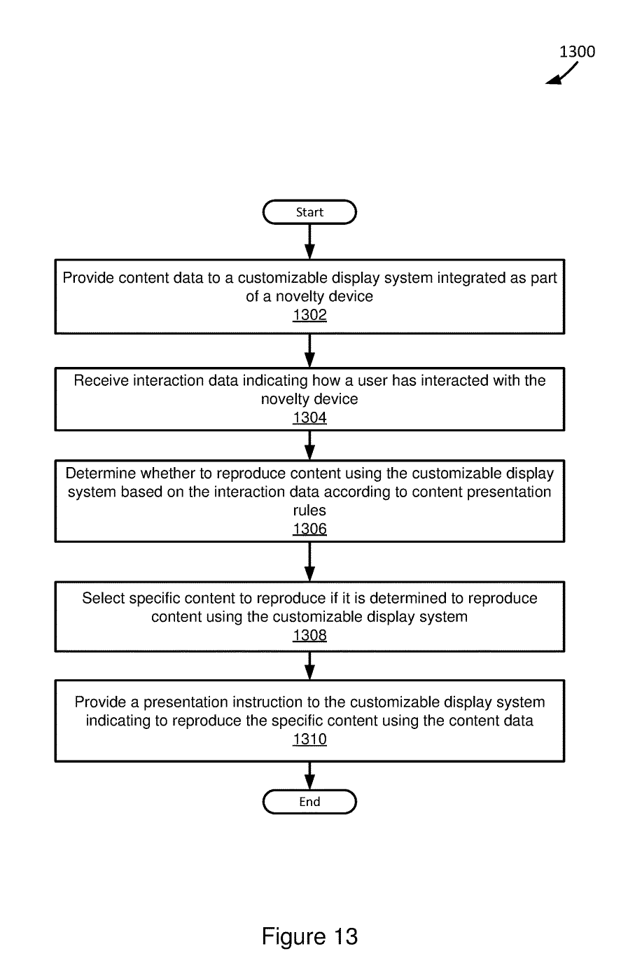

FIG. 13 depicts a flowchart 1300 of an example of a method for reproducing content at a customizable display system integrated as part of a novelty device based on user interaction with the novelty device. The flowchart 1300 begins at module 1302, where content data is provided to a customizable display system integrated as part of a novelty device. Content data can be provided to a customizable display system integrated as part of a novelty device by an applicable engine for provisioning content data, such as the content furnishing engines described in this paper. Content data can be provided to a customizable display system based on whether a user associated with the customizable display system has access rights to content. Additionally, content data can be provided to a customizable display system based on whether a user person to which a user associated with the customizable display system is mapped.

The flowchart 1300 continues to module 1304, where interaction data indicating how a user interacted with the novelty device is received. Interaction data can be received by an applicable system for managing reproduction of content at the customizable display system, such as the customized content reproduction management systems described in this paper. Additionally interaction data can be generated by an applicable sensor or system for detecting user interaction with the novelty device. For example, interaction data can be generated by and received from an orientation sensor integrated as part of the customizable display system and the novelty device.

The flowchart 1300 continues to module 1306, where it is determined whether to reproduce content using the customizable display system based on the interaction data according to content presentation rules. An applicable engine for managing reproduction of content on a customizable display system, such as the content reproduction direction engines described in this paper, can determine whether to reproduce content using the customizable display system based on the interaction data according to content presentation rules. For example, if interaction data indicates a user has shaken the novelty device, and content presentation rules specify reproducing new content at the customizable display system if it is determined that a user has shaken the novelty device, then it can be determined to reproduce the new content at the customizable display system.

The flowchart 1300 continues to module 1308, where specific content to reproduce is selected, if it determined to reproduce content using the customizable display system. An applicable engine for managing reproduction of content on a customizable display system, such as the content reproduction direction engines described in this paper, can select specific content to reproduce if it is determined to reproduce content using the customizable display system. For example, if it is determined to switch a customized message on the customizable display system based on the user's actions in shaking the novelty device, then a new customized message can be selected for display at the customizable display system. Specific content to reproduce at the content display system can be determined based on one or an applicable combination of content access rights, content presentation rules, and a user persona to which the user is mapped.

The flowchart 1300 continues to module 1310, where a presentation instruction indicating to reproduce the specific content using the content data is provided to the customizable display system. The customizable display system can subsequently reproduce the specific content using the content data in response to receiving the presentation instruction indicating to reproduce the specific content. An applicable engine for managing reproduction of content on a customizable display system, such as the content reproduction direction engines described in this paper, can provide a presentation instruction indicating to reproduce the specific content to the customizable display system. A presentation instruction can be provided in response to a determination to reproduce content using the customizable display system based on the interaction data according to content presentation rules.

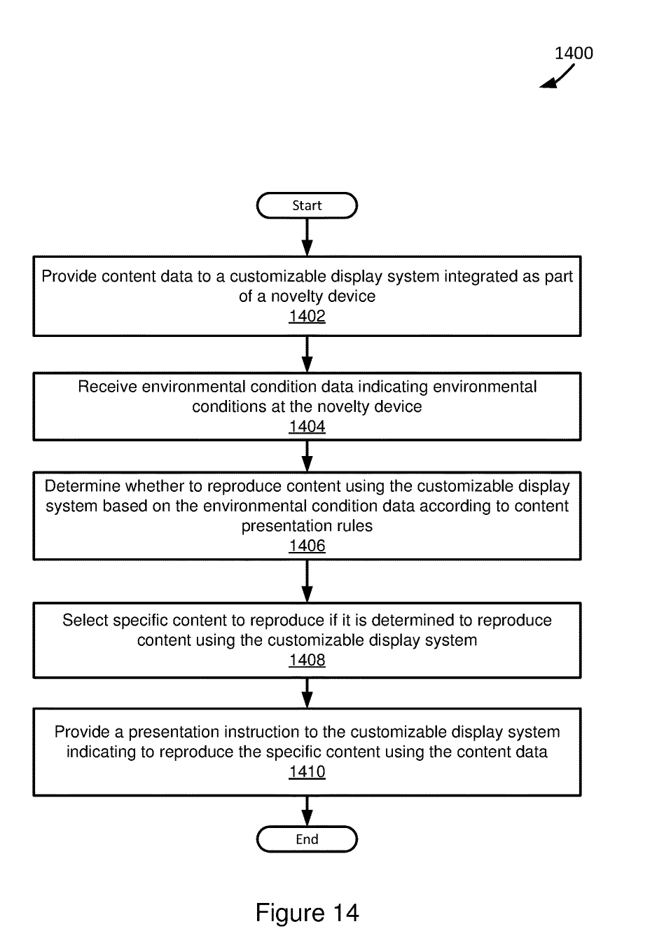

FIG. 14 depicts a flowchart 1400 of an example of a method for reproducing content at a customizable display system integrated as part of a novelty device based on environmental conditions at the novelty device. The flowchart 1400 begins at module 1402, where content data is provided to a customizable display system integrated as part of a novelty device. Content data can be provided to a customizable display system integrated as part of a novelty device by an applicable engine for provisioning content data, such as the content furnishing engines described in this paper. Content data can be provided to a customizable display system based on whether a user associated with the customizable display system has access rights to content. Additionally, content data can be provided to a customizable display system based on whether a user person to which a user associated with the customizable display system is mapped.

The flowchart 1400 continues to module 1404, where environmental conditions data indicating conditions of an environment at the novelty device is received. Environmental conditions data can be received by an applicable system for managing reproduction of content at the customizable display system, such as the customized content reproduction management systems described in this paper. Additionally environmental conditions data can be generated by an applicable sensor or system for detecting environmental conditions at the novelty device. For example, environmental conditions data can be generated by and received from a temperature sensor integrated as part of the customizable display system and the novelty device.

The flowchart 1400 continues to module 1406, where it is determined whether to reproduce content using the customizable display system based on the environmental conditions data according to content presentation rules. An applicable engine for managing reproduction of content on a customizable display system, such as the content reproduction direction engines described in this paper, can determine whether to reproduce content using the customizable display system based on the environmental conditions data according to content presentation rules. For example, if environmental conditions data indicates a specific temperature at the novelty device greater than a threshold temperature, and content presentation rules specify reproducing a new message at the customizable display system if it is determined that a temperature at the novelty device is greater than the threshold temperate, then it can be determined to reproduce a new message at the customizable display system.

The flowchart 1400 continues to module 1408, where specific content to reproduce is selected, if it determined to reproduce content using the customizable display system. An applicable engine for managing reproduction of content on a customizable display system, such as the content reproduction direction engines described in this paper, can select specific content to reproduce if it is determined to reproduce content using the customizable display system. For example, if it is determined to switch a customized message on the customizable display system based on the user's actions in shaking the novelty device, then a new customized message can be selected for display at the customizable display system. Specific content to reproduce at the content display system can be determined based on one or an applicable combination of content access rights, content presentation rules, and a user persona to which the user is mapped.

The flowchart 1400 continues to module 1410, where a presentation instruction indicating to reproduce the specific content using the content data is provided to the customizable display system. The customizable display system can subsequently reproduce the specific content using the content data in response to receiving the presentation instruction indicating to reproduce the specific content. An applicable engine for managing reproduction of content on a customizable display system, such as the content reproduction direction engines described in this paper, can provide a presentation instruction indicating to reproduce the specific content to the customizable display system. A presentation instruction can be provided in response to a determination to reproduce content using the customizable display system based on the environmental conditions data according to content presentation rules.

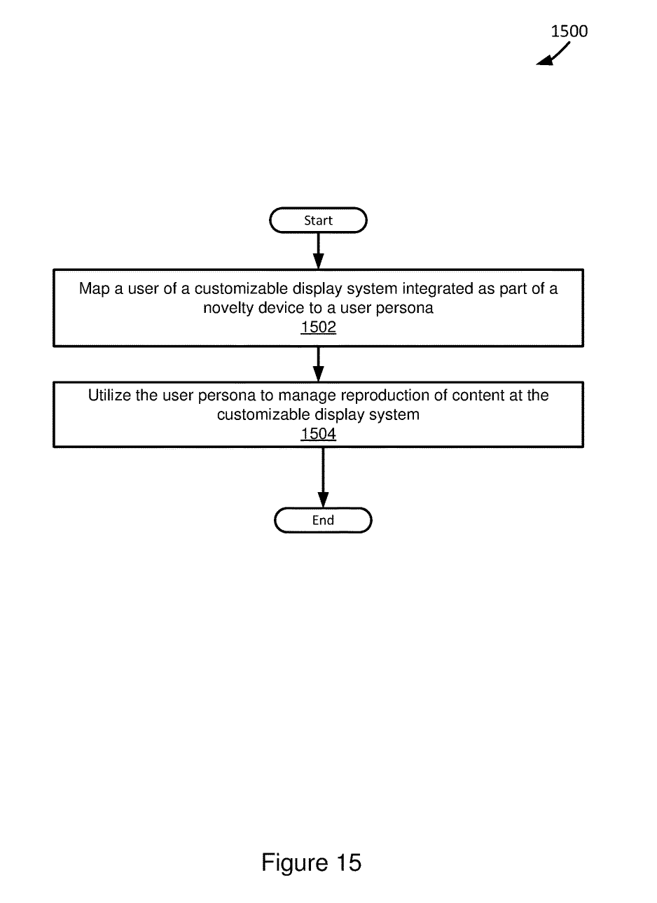

FIG. 15 depicts a flowchart 1500 of an example of a method of reproducing content on a customizable display system according to user personas. The flowchart 1500 begins at module 1502, where a user of a customizable display system integrated as part of a novelty device is mapped to a user persona. An applicable engine for mapping a user to a persona, such as the persona mapping engines described in this paper, can map a user of a customizable display system integrated as part of novelty device to a user persona. A user of a customizable display system integrated as part of novelty device can be mapped to a user persona based on market segmentation variables. For example if a user is a male between the ages of twenty and twenty-five living within a specific region, then the user can be mapped to a user persona including males between the ages of twenty and twenty-five living within the specific region.

The flowchart 1500 continues to module 1504, where the user persona is utilized to manage reproduction of content at the customizable display system. In utilizing the user persona to manage reproduction of content at the customizable display system, content data can be selectively provided to the customizable display system based on the user persona. For example, if specific content reproduced by specific content data is associated with a specific user persona and a user of the customizable display system is mapped to the specific user persona, then the specific content data can be provided to the customizable display system. Additionally, in utilizing the user persona to manage reproduction of content at the customizable display system, content presentation rules specific to the user persona can be applied in managing reproduction of content at the customizable display system. For example, if a user of the customizable display system is mapped to a user persona including males within the ages of twenty to twenty-five, then content presentation rules for controlling reproduction of content specific to males between the ages of twenty and twenty-five can be used in managing reproduction of content at the customizable display system.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
providing content data used in displaying customized messages within a list of customized messages to a customizable display system integrated as part of a novelty device, the customizable display system configured to display a first customized message from the list of customized messages using the content data;
receiving interaction data indicating how a user of the novelty device has physically manipulated the novelty device;
determining, using content presentation rules, whether to display another message at the customizable display system in response to the interaction data indicating how the user has physically manipulated the novelty device;
if it is determined to display the another message at the customizable display system in response to how the user has physically manipulated the novelty device:
selecting a second customized message from the list of customized messages to display at the customizable display system;
providing a first presentation instruction indicating to display the second customized message to the customizable display system, the customizable display system further configured to display the second customized message in place of the first customized message using the content data in response to receiving the first presentation instruction.

2. The method of claim 1, wherein the first customized message is a riddle or question and the second customized message is a hint to an answer or solution to the riddle or question.

3. The method of claim 1, wherein the customized messages and the list of customized messages are created by the user, the method further comprising:
receiving instructions from the user to configure the customizable display system to display the customized messages from the list of customized messages;
providing the content data used by the customizable display system to display the customized messages from the list of customized messages in response to the instructions received from the user.

4. The method of claim 1, further comprising:
providing additional content data used in displaying an advertisement to the customizable display system, the customizable display system further configured to display the advertisement using the additional content data;
determining, using the content presentation rules, whether to display the advertisement to the user in response to the interaction data indicating how the user has physically manipulated the novelty device;
if it is determined to display the advertisement at the customizable display system, providing a second presentation instruction to the customizable display indicating to display the advertisement at the customizable display system, the customizable display system further configured to display the advertisement using the additional content data in response to receiving the second presentation instruction.

5. The method of claim 1, further comprising:
mapping the user to a persona according to market segmentation variables;
selecting an advertisement to display to the user based on the persona to which the user is mapped;
providing additional content data used in displaying the advertisement to the customizable display system, the customizable display system further configured to display the advertisement using the additional content data;
determining, using the content presentation rules, whether to display the advertisement to the user in response to the interaction data indicating how the user has physically manipulated the novelty device;
if it is determined to display the advertisement at the customizable display system, providing a second presentation instruction to the customizable display indicating to display the advertisement at the customizable display system, the customizable display system further configured to display the advertisement in place of either the first customized message or the second customized message using the additional content data in response to receiving the second presentation instruction.

6. The method of claim 1, further comprising:
mapping the user to a persona according to market segmentation variables;
selecting additional content to reproduce for the user at the customizable display system based on the persona to which the user is mapped;
providing additional content data used in reproducing the additional content to the customizable display system, the customizable display system further configured to reproduce the additional content using the additional content data;
determining, using the content presentation rules, whether to reproduce the additional content for the user in response to the interaction data indicating how the user has physically manipulated the novelty device;
if it is determined to reproduce the additional content at the customizable display system, providing a second presentation instruction to the customizable display indicating to reproduce the additional content at the customizable display system, the customizable display system further configured to reproduce the additional content using the additional content data in response to receiving the second presentation instruction.

7. The method of claim 1, wherein the content presentation rules specify pseudo-randomly selecting the another message to display at the customizable display system in response to the interaction data indicating how the user has physically manipulated the novelty device.

8. The method of claim 1, wherein the customizable display system includes an energy harvester configured to convert kinetic energy generated by the user physically moving the novelty device into electrical energy, the electrical energy used to power the customizable display system

9. The method of claim 1, further comprising:
receiving environmental conditions data indicating environmental conditions at the novelty device;
determining, using the content presentation rules, whether to reproduce additional content at the customizable display system in response to the environmental conditions data indicating the environmental conditions at the novelty device;
providing a second presentation instruction indicating to reproduce the additional content to the customizable display system, if it is determined to reproduce additional content at the customizable display system in response to the environmental conditions at the novelty device, the customizable display system further configured to reproduce the additional content in response to receiving the second presentation instruction.

10. The method of claim 1, wherein the content presentation rules are generated, at least in part, based on input from the user.

11. The method of claim 1, further comprising:
maintaining content analytics data for the customizable display system based on reproduction of content at the customizable display system;
updating the content analytics data based on the display of the first customized message by the customizable display system and the interaction data.

12. The method of claim 1, wherein the content presentation rules are specific to the list of customized messages and include weighted presentation frequencies for displaying the customized messages within the list of customized messages.

13. The method of claim 1, wherein the content presentation rules are specific to the list of customized messages and specify a display order for the customized messages within the list of messages and the content presentation rules further including a command instructing to pseudo-randomly select a customized message of the customized messages to display after the customized messages have been displayed according to the display order.

14. The method of claim 1, wherein the content data is maintained in a location remote from the novelty device.

15. A system comprising:
a content furnishing engine configured to provide content data used in displaying customized messages within a list of customized messages to a customizable display system integrated as part of a novelty device, the customizable display system configured to display a first customized message from the list of customized messages using the content data;
a customized content reproduction management system configured to receive interaction data indicating how a user of the novelty device has physically manipulated the novelty device;
a content reproduction direction engine configured to:
determine, using content presentation rules, whether to display another message at the customizable display system in response to the interaction data indicating how the user has physically manipulated the novelty device;
select a second customized message from the list of customized messages to display at the customizable display system, if it is determined to display the another message at the customizable display system in response to how the user has physically manipulated the novelty device;
provide a first presentation instruction indicating to display the second customized message to the customizable display system, if it is determined to display the another message at the customizable display system in response to how the user has physically manipulated the novelty device, the customizable display system further configured to display the second customized message in place of the first customized message using the content data in response to receiving the first presentation instruction.

16. The system of claim 15, wherein the first customized message is a riddle or question and the second customized message is a hint to an answer or solution to the riddle or question.

17. The system of claim 15, wherein the customized messages and the list of customized messages are created by the user, the content furnishing engine further configured to:
receive instructions from the user to configure the customizable display system to display the customized messages from the list of customized messages;
provide the content data used by the customizable display system to display the customized messages from the list of customized messages in response to the instructions received from the user.

18. The system of claim 15, wherein:
the content furnishing engine is further configured to provide additional content data used in displaying an advertisement to the customizable display system, the customizable display system further configured to display the advertisement using the additional content data;
the content reproduction direction engine further configured to:
determine, using the content presentation rules, whether to display the advertisement to the user in response to the interaction data indicating how the user has physically manipulated the novelty device;
provide a second presentation instruction to the customizable display indicating to display the advertisement at the customizable display system, if it is determined to display the advertisement at the customizable display system, the customizable display system further configured to display the advertisement the additional content data in response to receiving the second presentation instruction.

19. The system of claim 15, further comprising a persona mapping engine configured to map the user to a persona according to market segmentation variables, wherein:
the content furnishing engine is further configured to:
select an advertisement to display to the user based on the persona to which the user is mapped;
provide additional content data used in displaying the advertisement to the customizable display system, the customizable display system further configured to display the advertisement using the additional content data;
the content reproduction direction engine further configured to:
determine, using the content presentation rules, whether to display the advertisement to the user in response to the interaction data indicating how the user has physically manipulated the novelty device;
provide a second presentation instruction to the customizable display indicating to display the advertisement at the customizable display system, if it is determined to display the advertisement at the customizable display system, the customizable display system further configured to display the advertisement in place of either the first customized message or the second customized message using the additional content data in response to receiving the second presentation instruction.

20. The system of claim 15, further comprising a persona mapping engine configured to map the user to a persona according to market segmentation variables, wherein:
the content furnishing engine is further configured to:
select additional content to reproduce for the user at the customizable display system based on the persona to which the user is mapped;
provide additional content data used in reproducing the additional content to the customizable display system, the customizable display system further configured to reproduce the additional content using the additional content data;
the content reproduction direction engine further configured to:
determine, using the content presentation rules, whether to reproduce the additional content for the user in response to the interaction data indicating how the user has physically manipulated the novelty device;
provide a second presentation instruction to the customizable display indicating to reproduce the additional content at the customizable display system, if it is determined to reproduce the additional content at the customizable display system, the customizable display system further configured to reproduce the additional content using the additional content data in response to receiving the second presentation instruction.

21. The system of claim 15, wherein the content presentation rules specify pseudo-randomly selecting the another message to display at the customizable display system in response to the interaction data indicating how the user has physically manipulated the novelty device.

22. The system of claim 15, wherein the customizable display system includes an energy harvester configured to convert kinetic energy generated by the user physically moving the novelty device into electrical energy, the electrical energy used to power the customizable display system

23. The system of claim 15, wherein:
the customized content reproduction management system is further configured to receive environmental conditions data indicating environmental conditions at the novelty device;
the content reproduction direction engine further configured to:
determine, using the content presentation rules, whether to reproduce additional content at the customizable display system in response to the environmental conditions data indicating the environmental conditions at the novelty device;
provide a second presentation instruction indicating to reproduce the additional content to the customizable display system, if it is determined to reproduce additional content at the customizable display system in response to the environmental conditions at the novelty device, the customizable display system further configured to reproduce the additional content in response to receiving the second presentation instruction.

24. The system of claim 15, further comprising a content reproduction analytics engine configured to:
maintain content analytics data for the customizable display system based on reproduction of content at the customizable display system;
update the content analytics data based on the display of the first customized message by the customizable display system and the interaction data.

25. The system of claim 15, wherein the content presentation rules are specific to the list of customized messages and include weighted presentation frequencies for displaying the customized messages within the list of customized messages.

26. The system of claim 15, wherein the content presentation rules are specific to the list of customized messages and specify a display order for the customized messages within the list of messages and the content presentation rules further including a command instructing to pseudo-randomly select a customized message of the customized messages to display after the customized messages have been displayed according to the display order.

27. The system of claim 15, further comprising a content gathering engine configured to maintain the content data in a location remote from the novelty device.

28. A system comprising:
means for providing content data used in displaying customized messages within a list of customized messages to a customizable display system integrated as part of a novelty device, the customizable display system configured to display a first customized message from the list of customized messages using the content data;
means for receiving interaction data indicating how a user of the novelty device has physically manipulated the novelty device;
means for determining, using content presentation rules, whether to display another message at the customizable display system in response to the interaction data indicating how the user has physically manipulated the novelty device;
means for selecting a second customized message from the list of customized messages to display at the customizable display system, if it is determined to display the another message at the customizable display system in response to how the user has physically manipulated the novelty device;
means for providing a first presentation instruction indicating to display the second customized message to the customizable display system, if it is determined to display the another message at the customizable display system in response to how the user has physically manipulated the novelty device, the customizable display system further configured to display the second customized message in place of the first customized message using the content data in response to receiving the first presentation instruction.

29. A novelty device comprising:
a housing with an inner reservoir containing a liquid with a dye to limit viewing of an item contained within the inner reservoir;
a customized die contained within the inner reservoir and having a density less than a fluid density of the liquid within the inner reservoir, the customized die including a first face, the first face including a first customized message comprised of one or a combination of indicia or script raised with respect to the first face, the first customized message provided through input of a user and the customized die created according to the input of the user and in response to receiving the input of the user;
a window in the housing forming part of the inner reservoir and configured to allow the user to view the inner reservoir and read the first customized message when the one or a combination of indicia or script raised with respect to the first face comes into contact with the window, while at least a portion of the die remains obscured from view by the dye within the liquid.
